(19) United States
(12) Patent Application Publication
(10) Pub. No.: US 2026/0242966 A1
(43) Pub. Date: Aug. 20, 2026

(54) WATER ELECTROLYSIS AND FUEL CELL STACKS WITH INSERT MOLDING AND METHODS OF MAKING THE SAME

(71) Applicant: BULLX RESEARCH, LLC, Sumner, ME (US)

(72) Inventors: Brian D. Bullecks, Sumner, ME (US); Andrei V. Smirnov, Vienna, VA (US)

(73) Assignee: BULLX RESEARCH, LLC, Sumner, ME (US)

(21) Appl. No.: 19/159,306

(22) PCT Filed: Feb. 25, 2024
(86) PCT No.: PCT/US2024/017188

§ 371 Date: Aug. 23, 2025

Related U.S. Application Data
(60) Provisional application No. 63/448,252, filed on Feb. 25, 2023.

(51) Int. Cl. C25B 9/77; C25B 1/04; C25B 9/19; C25B 9/60; H01M 8/0273; H01M 8/2483

(52) U.S. Cl. CPC C25B 9/77; C25B 1/04; C25B 9/19; C25B 9/60; H01M 8/0273; H01M 8/2483

(57) ABSTRACT

The invention provides an electrolysis cell for alkaline water electrolysis as well as a method to make the cell with application of insert molding procedures. The invention also includes cells for PEM and AEM electrolysis and for fuel cell function. The cell is characterized by low material and manufacturing costs as well as the possibility to significantly scale up production while maintaining expected operational integrity. This invention enables one to apply insert-molding to manufacture the various types of specific cells and combine each type into stacks. In particular, the insert molding is applied to the membrane/diaphragm and the separator plate of each cell. Cross flow and co-flow configurations are described.

### BACKGROUND OF THE INVENTION

### 1. Fields of the Invention

The present invention relates to the fields of water electrolysis and electricity generation with a fuel cell. More particularly, the present invention relates to an apparatus and method of making the apparatus formed of one or more cells including molded inserts. The invention includes making the cells with insert molding and combining the cells into a stack.

### 2. Description of the Prior Art

Water electrolysis is the process of extracting hydrogen and oxygen gases from water solutions by means of splitting the water with an electrical current. In particular, in alkaline water electrolysis, water contains alkaline minerals such as sodium or potassium hydroxide and has a higher PH value. An electrolyzer cell is a device for water electrolysis. The process of splitting water with the use of an alkaline electrolyte is known as Alkaline Water Electrolysis (AWE). In electrolysis, water is the feed to a cell, electricity is applied across the cell or a stack of cells through which the water is fed, and hydrogen and oxygen are generated from the splitting of the water molecules in the feed.

The majority of commercial water electrolyzers have high costs associated with their manufacture. Current systems include combinations of expensive materials that may include rare-earth metals, precious metals, and metal alloys in the electrode materials. Additionally, current electrolysis cell designs are generally made of many components assembled into a cell by hand, resulting in multiple component manufacturing and assembly steps with high costs from manufacturing and assembly. As one example and without being limiting, water electrolyzers include bi-polar plates, among other components. The bi-polar plates are primarily made of electrically conducting material and of appropriate size and shape to separate streams of anode and cathode fluids passing over the electrodes. Prior to the present invention, the electrolyzers also included separate current collectors coupled to the bi-polar plates. Making at least those components more efficiently would provide for satisfactory operation with reduced manufacturing cost. For example, both components are made separately and then joined together. Making them of a single plate would be more efficient.

In a related technology, fuel cells employ hydrogen and oxygen as the feed to a cell, and water and electricity are generated by effectively combining the hydrogen and oxygen. In simple terms, the fuel cell reaction is represented by: H2+1/2O2-->H2O. This is an exothermic reaction and part of the energy from the reaction is in the form of electricity and the remainder is in the form of heat. In a Proton (or Polymer) Exchange Membrane (PEM) fuel cell, hydrogen on the anode is oxidized and gives up two electrons represented by: H2-->2H++2e−. The electrons travel from the anode to the cathode, and, in the process, do work. The H+ (protons) move across the membrane to the cathode. On the cathode, two protons, one oxygen atom and two electrons combine to form water represented by: 2H++2e−+1/2O2-->H2O.

In an Anion Exchange Membrane (AEM) fuel cell, air and water vapor are fed to the cathode and the following reaction takes place: 1/2O2+H2O+2e−-->2OH—. The hydroxide (OH—) is transported across the membrane to the anode. On the anode, hydrogen reacts with the OH-represented by: H2+2OH—-->2H2O+2e−. As in the PEM fuel cell, the electrons travel from the anode to the cathode and do work in the external circuit. In both the PEM and AEM fuel cells, the overall reaction is 1/2O2+H2-->H2O.

Electrolysis reactions can similarly be represented as follows: For AWE reactions: Cathode: 4H2O+4e−-->2H2+4OH—, Anode: 4OH—-->O2+2H2O+4e−, and Overall: 2H2O-->2H2+O2. For PEM Water Electrolysis (PEMWE), the reactions are represented as Cathode: 4H++4e−-->2H2, Anode: 2H2O-->4H++4e−+O2, and Overall: 2H2O-->2H2+O2. Finally, for AEM Water Electrolysis (AEMWE), the reactions are as stated for the AWE reactions disclosed herein.

The functional cells for hydrogen fuel generation (electrolysis) and hydrogen fuel consumption (fuel cell) have similarities in that a membrane is ordinarily employed to separate the cathode and anode channels. The membrane facilitates ion transport while the splitting and combining of ions happens at the electrodes. The specific chemistries of the membranes and electrodes employed in each case vary but the physical structures of the cells are configured in substantially the same way. Therefore, the limitations described above with respect to the apparatus and method of making water electrolysis cells generally applies to fuel cell systems.

What is needed is a better way of making electrolyzer cells, fuel cells, and stacks of such cells. The improved cells and way of making those cells should overcome the above-mentioned limitations of expensive materials, numerous components, expensive manufacturing procedures and labor costs.

### SUMMARY OF THE INVENTION

It is an object of the present invention to provide a better way of making electrolyzer cells, fuel cells, and stacks of such cells. It is also an object of the invention to provide such improved cells that are made with less expensive materials, a reduction in the number of components, reduction in the required manufacturing procedures, and a reduction in labor costs.

These objects are achieved with the present invention, which provides improved electrolyzer and fuel cells and ways of making those cells that overcome the limitations of expensive materials, numerous components, expensive manufacturing procedures and labor costs. Specifically, low cost, highly scalable plastic insert/over molding techniques are employed to make the cells. By use of these techniques to form much of the electrolysis/fuel cell and sealing structure, the integration of numerous features and components can be realized leading to a reduced part count and high degree of automation leading to reduced labor costs associated with electrolysis/fuel cell and stack manufacture and assembly. Insert molding means a process known to those skilled in the art of injection molding, combining or forming plastic parts around other, preformed plastic, non-plastic, or insert components. The present invention uses the insert molding (injection molding) to form much of the structure of the cells and to form or otherwise integrate all components of the cells. This is substantially distinct from prior cells and cell manufacturing that are formed of a large number of intricate parts that must be joined together.

In general terms, an electrolyzer cell includes a cell frame, electrodes in the form of an anode and a cathode, a diaphragm or membrane (dependent on particular cell functionality required), a bi-polar plate, and channels for the transport of cathode and anode volumes between the electrodes.

While the terms diaphragm and membrane may be used interchangeably herein, they are not functionally identical. Both diaphragms and membranes are used as separators in electrolysis and fuel cells to prevent gas crossover and so with respect to that particular functionality they are interchangeable. However, the membrane in a PEM or AEM has ion selective functional groups and also serves as the electrolyte to facilitate ion transport. In AWE, the diaphragm is only a porous separator that when saturated with the electrolyte solution allows ion and water transport. It does not serve as the electrolyte. In all cases the membranes or diaphragms do not conduct electrons.

The AWE referred to above employs a cell of the type generally described. The cell apparatus and method of making the cell apparatus of the present invention can also be applied to PEMWEs and AEMWEs.

In PEM electrolysis, deionized water is fed to the cell, which water may be fed to the cathode and anode of the cell or to the anode only. The membrane of a PEMWE is polymeric and generally contains one or more functional groups that can facilitate the transport of protons. Sulphonic acids represent one such functional group. The Nafion® membrane available from Chemours is one such polymer membrane. The electrodes of the PEM are typically made of Platinum group metals but not limited thereto. In particular, Platinum is often used on the cathode and Iridium is often used on the anode.

The construct of the AEM electrolyzer is similar to that of the PEM electrolyzer with a membrane that is polymeric and generally contains one or more functional groups that can facilitate the transport of hydroxide ions across the membrane (as opposed to the protons transported across the PEM membrane). The catalyst for the electrodes may also be from the Platinum metals group but may alternatively be Nickel-based.

The invention for all cells described herein includes insert molding the plastic cell frame over the diaphragm/membrane and forming the cathode and anode volumes with the one formed frame.

The channels are automatically formed that direct the anode and cathode streams to respective surfaces of the electrodes and the manifolds providing the out flow of liquids and gases from anode and cathode chambers. In a similar manner, a seal ring, which may also be referred to herein as a gasket, is insert molded over the bi-polar plate thereby separating different electrolyzer cells, which simplifies the assembly of individual electrolyzer cells so formed into a stack of cells ultimately used to conduct electrolysis.

The inventive method of manufacturing enables the reduction of material costs, labor costs, and shortens the manufacturing time. It reduces material costs through the incorporation of multiple cell components into one molded cell frame or seal ring using low cost chemically resistant polymer materials. The method removes multiple individual components, reduces the use of more expensive materials, and provides chemical and electrical resistance without the use of additional materials or components. The resultant cells are themselves unique in the field.

In general, a first embodiment of an apparatus of the invention for splitting a water feed into hydrogen and oxygen includes a separator arranged to enable ionic exchange between an anode stream and a cathode stream of the water feed, wherein the separator is a diaphragm or a membrane, an anode electrode attached, or in proximity, to a first side of the separator, a cathode electrode attached, or in proximity, to a second side of the separator, a cell frame including one or more cell inlets and one or more cell outlets together arranged to direct the anode stream to the first side of the separator and the cathode stream to the second side of the separator, wherein the cell frame is formed of a nonmetallic material insert molded over the separator to constrain the separator therein, and a bi-polar plate made of electrically conducting material spaced from the separator and arranged to separate the anode and cathode streams passing over the anode electrode and the cathode electrode. The apparatus of this first embodiment can be a first such apparatus, wherein the first apparatus is joined to a second apparatus having the same construction as that of the first apparatus, wherein the bi-polar plate is further configured of appropriate size and shape to separate the anode and cathode streams passing over the anode and cathode electrodes of the first apparatus and the second apparatus, and further comprising an interconnector for interconnecting together the electrode of the first apparatus with the complementary electrode of the second apparatus where complementary refers to an anode-cathode pair. The apparatus may further include a gasket for joining together the first apparatus and the second apparatus, wherein the gasket is formed of a nonmetallic material insert molded over the bi-polar plate such that the bi-polar plate can be joined with the cell frame without inhibiting flow of the anode and cathode streams in and out of the first apparatus and the second apparatus. The cell frame may further include an anode inlet manifold, a cathode inlet manifold, an anode outlet manifold, and a cathode outlet manifold, wherein the cell frame and the gasket are configured in such a way that when the first apparatus is joined together with the second apparatus, the cell inlets for the anode streams of the first apparatus and the second apparatus are merged into the anode inlet manifold, the cell outlets for the anode streams of the first apparatus and the second apparatus are merged into the outlet manifold, the cell inlets for the cathode streams of the first apparatus and the second apparatus are merged into the cathode inlet manifold, and the cell outlets for the cathode streams of the first apparatus and the second apparatus are merged into the cathode outlet manifold. The cell frame and the gasket may be configured in such a way that the anode and cathode streams pass on either side of the separator in either a co-flow configuration or a cross-flow configuration. The cell frame may be positioned in such a way that the flow direction of the anode and the cathode streams is approximately 45 degrees to the horizontal plane, whereby the separation of gaseous and liquid phases is facilitated. The bi-polar plate may include a current collector. The first apparatus combined with the second apparatus can form an electrolyzer stack, which can include end plates to compress the first apparatus, the second apparatus, and the gasket together to form a gas-tight seal for the stack. The stack may include insulators arranged to isolate the end plates from electrical potential of the stack and the anode and cathode streams. The insulators can be made of an electrically insulative material by injection molding or machining. In a version of the apparatus of the first embodiment, the bi-polar plate is a full diameter bi-polar plate and wherein the stack and manifold seals are over molded. The separator may be a Proton Exchange Membrane (PEM). The PEM may be coated with a catalyst. Alternatively, the separator may be an Anion Exchange Membrane. The apparatus of the first embodiment may also include a first Gas Diffusion Layer (GDL) joined to the anode electrode and a second GDL joined to the cathode electrode. A first microporous layer may be joined to the first GDL and a second microporous layer may be joined to the second GDL. In a version of the first embodiment of the apparatus, the bipolar plate may be sized the same as the electrode and having the gasket over molded along its perimeter. There may be a gap between the separator and the anode electrode and a gap between the separator and the cathode electrode. Alternatively, there may be no or minimal gap between the separator and the anode electrode and there may be no or minimal gap between the separator and the cathode electrode.

A second embodiment of an apparatus of the invention for splitting a water feed of an electrolyte stream into hydrogen and oxygen without a separator includes an anode electrode, a cathode electrode, a cell frame including one or more cell inlets and one or more cell outlets together arranged to direct the electrolyte stream between the anode electrode and the cathode electrode, wherein the cell frame is formed of a nonmetallic material insert molded over the anode electrode and cathode electrode, and a bi-polar plate having an anode side electrically connected to the anode electrode and a cathode side electrically connected to the cathode electrode.

A third embodiment of an apparatus of the invention for generating electricity and water from hydrogen and oxygen of a fluid feed includes a separator arranged in the fluid feed to enable ionic exchange between an anode stream and a cathode stream of the fluid feed, wherein the separator is a membrane, an anode electrode attached, or in proximity, to a first side of the separator, a cathode electrode attached, or in proximity, to a second side of the separator, a cell frame including one or more cell inlets and one or more cell outlets together arranged to direct the anode stream to the first side of the separator and the cathode stream to the second side of the separator, wherein the cell frame is formed of a nonmetallic material insert molded over the separator to constrain the separator therein, a bi-polar plate made of electrically conducting material spaced from the separator and arranged to separate the anode and cathode streams passing over the anode electrode and the cathode electrode, and a first Gas Diffusion Layer (GDL) joined to the anode electrode and a second GDL joined to the cathode electrode. Th apparatus of this first embodiment can be a first such apparatus, wherein the first apparatus wherein the first apparatus is joined to a second apparatus having the same construction as that of the first apparatus, wherein the bi-polar plate is further configured of appropriate size and shape to separate the anode and cathode streams passing over the anode and cathode electrodes of the first apparatus and the second apparatus, and further comprising an interconnector for interconnecting together the separators of the first apparatus and the second apparatus via their respective opposing anode electrodes and cathode electrodes. The apparatus may include a gasket for joining together the first apparatus and the second apparatus, wherein the gasket is formed of a nonmetallic material insert molded over the bi-polar plate such that the bi-polar plate can be joined with the cell frame without inhibiting flow of the anode and cathode streams in and out of the first apparatus and the second apparatus. The cell frame may further include an anode inlet manifold, a cathode inlet manifold, an anode outlet manifold, and a cathode outlet manifold, wherein the cell frame and the gasket are configured in such a way that when the first apparatus is joined together with the second apparatus, the cell inlets for the anode streams of the first apparatus and the second apparatus are merged into the anode inlet manifold, the cell outlets for the anode streams of the first apparatus and the second apparatus are merged into the outlet manifold, the cell inlets for the cathode streams of the first apparatus and the second apparatus are merged into the cathode inlet manifold, and the cell outlets for the cathode streams of the first apparatus and the second apparatus are merged into the cathode outlet manifold. The cell frame and the gasket may be configured in such a way that the anode and cathode streams pass on either side of the separator in either a co-flow configuration or a cross-flow configuration. The cell frame may be positioned in such a way that the flow direction of the anode and the cathode streams is approximately 45 degrees to the horizontal plane. The bi-polar plate may include a current collector. The third embodiment of the apparatus of the invention may be identified as a first apparatus that can be combined with the second apparatus forms a fuel cell stack, the fuel cell stack further comprising end plates to compress the first apparatus, the second apparatus, and the gasket together to form a gas-tight seal for the stack. Insulators may be arranged to isolate the end plates from electrical potential of the stack and the anode and cathode streams. The insulators may be made of an electrically insulative material by injection molding or machining. The bi-polar plate may be a full diameter bi-polar plate wherein the stack and manifold seals are over molded. The separator may be a Proton Exchange Membrane (PEM). The PEM may be coated with a catalyst. Alternatively, the separator may be an Anion Exchange Membrane. The third embodiment of the apparatus may include a first microporous layer joined to the first GDL and a second microporous layer joined to the second GDL. The bipolar plate may be sized the same as the electrode and having the gasket over molded along its perimeter.

A fourth embodiment of an apparatus of the invention for splitting a water feed into hydrogen and oxygen includes a separator arranged to enable ionic exchange between an anode stream and a cathode stream of the water feed, wherein the separator is a diaphragm or a membrane, an anode electrode attached, or in proximity, to a first side of the separator, a cathode electrode attached, or in proximity, to a second side of the separator, a bi-polar plate made of electrically conducting material spaced from the separator and arranged to separate the anode and cathode streams passing over the anode electrode and the cathode electrode, and a cell frame including one or more cell inlets and one or more cell outlets together arranged to direct the anode stream to the first side of the separator and the cathode stream to the second side of the separator, wherein the cell frame is formed of a nonmetallic material insert molded over the bi-polar plate to constrain the bi-polar plate therein. The apparatus of the fourth embodiment of the invention may be referred to as a first apparatus that may be joined to a second apparatus having the same construction as that of the first apparatus, wherein the bi-polar plate is further configured of appropriate size and shape to separate the anode and cathode streams passing over the anode and cathode electrodes of the first apparatus and the second apparatus, and further comprising an interconnector for interconnecting together the electrode of the first apparatus with the complementary electrode of the second apparatus where complementary refers to an anode-cathode pair. The apparatus may include a gasket for joining together the first apparatus and the second apparatus, wherein the gasket is formed of a nonmetallic material insert molded over the separator such that the separator can be joined with the cell frame without inhibiting flow of the anode and cathode streams in and out of the first apparatus and the second apparatus. The cell frame further may include an anode inlet manifold, a cathode inlet manifold, an anode outlet manifold, and a cathode outlet manifold, wherein the cell frame and the gasket are configured in such a way that when the first apparatus is joined together with the second apparatus, the cell inlets for the anode streams of the first apparatus and the second apparatus are merged into the anode inlet manifold, the cell outlets for the anode streams of the first apparatus and the second apparatus are merged into the outlet manifold, the cell inlets for the cathode streams of the first apparatus and the second apparatus are merged into the cathode inlet manifold, and the cell outlets for the cathode streams of the first apparatus and the second apparatus are merged into the cathode outlet manifold. The cell frame and the gasket may be configured in such a way that the anode and cathode streams pass on either side of the separator in either a co-flow configuration or a cross-flow configuration. The cell frame may be positioned in such a way that the flow direction of the anode and the cathode streams is approximately 45 degrees to the horizontal plane, whereby the separation of gaseous and liquid phases is facilitated. The bi-polar plate may include a current collector. The first apparatus of the fourth embodiment may be combined with the second apparatus to form an electrolyzer stack, the electrolyzer stack further comprising end plates to compress the first apparatus, the second apparatus, and the gasket together to form a gas-tight seal for the stack. Insulators may be arranged to isolate the end plates from electrical potential of the stack and the anode and cathode streams. The insulators may be made of an electrically insulative material by injection molding or machining. The bi-polar plate may be a full diameter bi-polar plate and wherein the stack and manifold seals are over molded. The separator may be a Proton Exchange Membrane (PEM). The PEM may be coated with a catalyst. Alternatively, the separator may be an Anion Exchange Membrane. The fourth embodiment of the apparatus may include a first Gas Diffusion Layer (GDL) joined to the anode electrode and a second GDL joined to the cathode electrode. The apparatus may include a first microporous layer joined to the first GDL and a second microporous layer joined to the second GDL. There may be a gap between the separator and the anode electrode and a gap between the separator and the cathode electrode. Alternatively, there may be no or minimal gap between the separator and the anode electrode and there is no or minimal gap between the separator and the cathode electrode.

A fifth embodiment of an apparatus of the invention for generating electricity and water from hydrogen and oxygen of a fluid feed includes a separator arranged in the fluid feed to enable ionic exchange between an anode stream and a cathode stream of the fluid feed, wherein the separator is a membrane, an anode electrode attached, or in proximity, to a first side of the separator, a cathode electrode attached, or in proximity, to a second side of the separator, a bi-polar plate made of electrically conducting material spaced from the separator and arranged to separate the anode and cathode streams passing over the anode electrode and the cathode electrode, a cell frame including one or more cell inlets and one or more cell outlets together arranged to direct the anode stream to the first side of the separator and the cathode stream to the second side of the separator, wherein the cell frame is formed of a nonmetallic material insert molded over the bi-polar plate to constrain the bi-polar plate therein, and a first Gas Diffusion Layer (GDL) joined to the anode electrode and a second GDL joined to the cathode electrode. The apparatus of the fifth embodiment of the invention may be referred to as a first apparatus that may be joined to a second apparatus having the same construction as that of the first apparatus, wherein the bi-polar plate is further configured of appropriate size and shape to separate the anode and cathode streams passing over the anode and cathode electrodes of the first apparatus and the second apparatus, and further comprising an interconnector for interconnecting together the separators of the first apparatus and the second apparatus via their respective opposing anode electrodes and cathode electrodes. The apparatus may further include a gasket for joining together the first apparatus and the second apparatus, wherein the gasket is formed of a nonmetallic material insert molded over the separator such that the separator can be joined with the cell frame without inhibiting flow of the anode and cathode streams in and out of the first apparatus and the second apparatus. The cell frame may include an anode inlet manifold, a cathode inlet manifold, an anode outlet manifold, and a cathode outlet manifold, wherein the cell frame and the gasket are configured in such a way that when the first apparatus is joined together with the second apparatus, the cell inlets for the anode streams of the first apparatus and the second apparatus are merged into the anode inlet manifold, the cell outlets for the anode streams of the first apparatus and the second apparatus are merged into the outlet manifold, the cell inlets for the cathode streams of the first apparatus and the second apparatus are merged into the cathode inlet manifold, and the cell outlets for the cathode streams of the first apparatus and the second apparatus are merged into the cathode outlet manifold. The cell frame and the gasket may be configured in such a way that the anode and cathode streams pass on either side of the separator in either a co-flow configuration or a cross-flow configuration. The cell frame may be positioned in such a way that the flow direction of the anode and the cathode streams is approximately 45 degrees to the horizontal plane. The bi-polar plate may include a current collector. The first apparatus of the fifth embodiment may be combined with the second apparatus to form a fuel cell stack, the fuel cell stack further comprising end plates to compress the first apparatus, the second apparatus, and the gasket together to form a gas-tight seal for the stack. Insulators may be arranged to isolate the end plates from electrical potential of the stack and the anode and cathode streams. The insulators may be made of an electrically insulative material by injection molding or machining. The bi-polar plate may be a full diameter bi-polar plate and wherein the stack and manifold seals are over molded. The separator may be a Proton Exchange Membrane (PEM). The PEM may be coated with a catalyst. Alternatively, the separator may be an Anion Exchange Membrane. The apparatus may also include a first microporous layer joined to the first GDL and a second microporous layer joined to the second GDL. The bipolar plate may be sized the same as the electrode and having the gasket over molded along its perimeter.

A first embodiment of a method of the present invention for making an electrochemical cell, the method includes the steps of securing a separator in a first mold, wherein the separator is a diaphragm or a membrane, molding by insert molding in the first mold a cell frame over the separator to provide structural support to the separator, wherein the cell frame is formed of a nonmetallic material that is molten when inserted into the first mold and solidifies while in the first mold, securing a bipolar plate in a second mold, molding by insert molding in the second mold a gasket over the bipolar plate with a shape that fits the cell frame, providing an anode electrode near a first side of the separator, providing a cathode electrode near a second side of the separator, and joining the bi-polar plate with the anode electrode and the cathode electrode so that the cell frame comes in contact with the gasket. The method may also include the step of joining the bi-polar plate with the separator via contact of the bipolar plate with the anode electrode and the cathode electrode. The method may also include the step of joining a first Gas Diffusion Layer (GDL) to the anode electrode and joining a second GDL to the cathode electrode. A majority of the cell frame may be formed in the first mold by overmolding with the nonmetallic material. A majority of the gasket may be formed in the second mold by overmolding with the nonmetallic material. The first mold may include a heated mold portion and a cold plate portion, wherein the heated portion is heated to enable flow of the nonmetallic material into the mold to encase a portion of the separator, and wherein the cold plate portion secures the separator in the mold and is cooled to keep a substantial portion of the separator cool while the nonmetallic material is flowing into the first mold. The method may further include joining together a plurality of the electrochemical cells to form an electrochemical stack. The stack may be formed by tactile interlocking of corresponding portions of adjacent ones of the electrochemical cells in the stack. The cell frame may be formed having a symmetrical design to facilitate assembly of individual electrochemical cells of the stack, wherein the symmetrical design reduces sensitivity to orientation of adjacent cell frames and gaskets. The method may include the step of enabling positive feedback in joining the electrochemical cells together to form the stack to confirm proper cell alignment. The method may further include the step of securing both ends of the stack with removable end plates. The method may include the step of securing a shell around a perimeter of the stack, wherein the shell is selected to enable application of increased operational pressure of the stack. The cell frame may be configured to enable a cross-flow of the anode and cathode streams along the electrode surfaces attached or in close proximity to the first side and the second side of the separator. The electrochemical cell may be positioned in such a way that the flow direction of the anode and cathode streams is approximately 45 degrees to the horizontal plane, whereby the separation of gaseous and liquid phases is facilitated. The method may furth include the step of joining together a first electrochemical cell with a second electrochemical cell to establish in the stack a common anode inlet manifold into the joined cells and a common anode outlet manifold from the joined cells and likewise provides for a common cathode inlet manifold and a common cathode outlet manifold for the joined cells, in forming the stack. Indentations may be made in the bi-polar plate to form electrical contacts for making contact between the anode electrode of the first electrochemical cell and the cathode electrode of the second electrochemical cell. The method may further include the step of joining a current collector to the bi-polar plate. The method may include the step of isolating the end plates from the electrical potential of the stack and from anode and cathode streams of the stack. The bi-polar plate, consisting of an electrically conducting material, may be overmolded with the gasket, made of electrically insulating polymer materials thus providing electrical isolation to exterior surfaces of the electrolysis stack. The cell frame may be configured to enable a co-flow of anode and cathode streams of the electrochemical cell along the anode electrode and the cathode electrode attached to the separator. The separator may be a Proton Exchange Membrane. The separator may be an Anion Exchange Membrane. The separator may be a diaphragm. In an embodiment, the electrochemical cell is an electrolysis cell. Alternatively, the electrochemical cell may be a fuel cell.

In a second embodiment of the method of the invention for making an electrochemical cell, the method includes the steps of securing a bi-polar plate in a first mold, molding by insert molding in the first mold a cell frame over the bi-polar plate to provide structural support to the bi-polar plate, wherein the cell frame is formed of a nonmetallic material that is molten when inserted into the first mold and solidifies while in the first mold, securing a separator in a second mold, wherein the separator is a diaphragm or a membrane, molding by insert molding in the second mold a gasket over the separator with a shape that fits the cell frame, providing an anode electrode near a first side of the separator, providing a cathode electrode near a second side of the separator, and joining the bi-polar plate with the anode electrode and the cathode electrode so that the cell frame comes in contact with the gasket. The method may also include the step of joining the bi-polar plate with the separator via contact of the bipolar plate with the anode electrode and the cathode electrode. The method may also include the step of joining a first Gas Diffusion Layer (GDL) to the anode electrode and joining a second GDL to the cathode electrode. A majority of the cell frame may be formed in the first mold by overmolding with the nonmetallic material. A majority of the gasket may be formed in the second mold by overmolding with the nonmetallic material. The first mold may include a heated mold portion and a cold plate portion, wherein the heated portion is heated to enable flow of the nonmetallic material into the mold to encase a portion of the bi-polar plate, and wherein the cold plate portion secures the bi-polar plate in the mold and is cooled to keep a substantial portion of the bi-polar plate cool while the nonmetallic material is flowing into the first mold. The method may further include joining together a plurality of the electrochemical cells to form an electrochemical stack. The stack may be formed by tactile interlocking of corresponding portions of adjacent ones of the electrochemical cells in the stack. The cell frame may be formed having a symmetrical design to facilitate assembly of individual electrochemical cells of the stack, wherein the symmetrical design reduces sensitivity to orientation of adjacent cell frames and gaskets. The method may include the step of enabling positive feedback in joining the electrochemical cells together to form the stack to confirm proper cell alignment. The method may further include the step of securing both ends of the stack with removable end plates. The method may include the step of securing a shell around a perimeter of the stack, wherein the shell is selected to enable application of increased operational pressure of the stack. The cell frame may be configured to enable a cross-flow of the anode and cathode streams along the electrode surfaces attached or in close proximity to the first side and the second side of the separator. The electrochemical cell may be positioned in such a way that the flow direction of the anode and cathode streams is approximately 45 degrees to the horizontal plane, whereby the separation of gaseous and liquid phases is facilitated. The method may furth include the step of joining together a first electrochemical cell with a second electrochemical cell to establish in the stack a common anode inlet manifold into the joined cells and a common anode outlet manifold from the joined cells and likewise provides for a common cathode inlet manifold and a common cathode outlet manifold for the joined cells, in forming the stack. Indentations may be made in the bi-polar plate to form electrical contacts for making contact between the anode electrode of the first electrochemical cell and the cathode electrode of the second electrochemical cell. The method may further include the step of joining a current collector to the bi-polar plate. The method may include the step of isolating the end plates from the electrical potential of the stack and from anode and cathode streams of the stack. The bi-polar plate, consisting of an electrically conducting material, may be overmolded with the gasket, made of electrically insulating polymer materials thus providing electrical isolation to exterior surfaces of the electrolysis stack. The cell frame may be configured to enable a co-flow of anode and cathode streams of the electrochemical cell along the anode electrode and the cathode electrode attached to the separator. The separator may be a Proton Exchange Membrane. The separator may be an Anion Exchange Membrane. The separator may be a diaphragm. In an embodiment, the electrochemical cell is an electrolysis cell. Alternatively, the electrochemical cell may be a fuel cell.

In one embodiment, the invention provides an AWE cell, which is a device for alkaline water electrolysis. The cell includes a diaphragm, which is a barrier separating anode and cathode streams, enabling ionic exchange between said streams, and preventing both gas cross-over and electronic conduction. It further includes electrodes, which are layers of electrochemically active conducting material attached or in proximity to either side of the diaphragm and enabling electro-chemical reactions to occur. The cell includes a cell frame, which is a frame made of a non-metallic material such as a plastic material, including means for flow control and which is molded over the diaphragm by applying an insert molding procedure and supplied with cell inlet and cell outlet features that direct the anode and cathode flow to pass over respective electrodes on both sides of the diaphragm. The cell also includes a bi-polar plate, which is a plate made of electrically conducting material and of appropriate size and shape to separate streams of anode and cathode fluids passing over the electrodes. The bi-polar plate is also arranged to couple two different electrolysis cells including means for inter-connecting the electrodes. The bi-polar plate may be manufactured to include a current collector as part of a single plate structure rather than making those components of multiple plates. The cell includes a gasket for joining the electrolysis cell to another electrolysis cell and which is molded over the bi-polar plate by applying an insert molding procedure such that it can be joined with the cell frame without inhibiting anode and cathode flow in and out of the electrolysis cell. The cell frame and the gasket are configured in such a way that when one electrolysis cell is joined together with another electrolysis cell, the anode cell inlet features of all such joined together cells are merged into a single anode inlet manifold, the anode outlet features of all cells are merged into a single anode outlet manifold and likewise, cathode inlets of all cells are merged into a single cathode inlet manifold, and cathode outlets of all cells are merged into a single cathode outlet manifold.

In an embodiment, the cell frame and the gasket are configured in such a way that the anode and cathode streams pass on either side of the diaphragm in a cross-flow configuration. In another embodiment, the frame and gasket are configured for the streams to co-flow. In an embodiment, the electrolysis cell is positioned so that the flow direction of the anode and the cathode streams is about 45 degrees to the horizontal plane, whereby the separation of gaseous and liquid phases is facilitated. In a gapped AWE design, the electrodes can be attached directly to either side of the bipolar plate. In this design, current collectors are not needed. The electrodes can be attached to the bipolar plates by welding or any other suitable means of joining metallic components. This design reduces the number of steps during stack assembly. Sheet metal forming is simplified with no need for stamping.

In a PEM electrolyzer embodiment of the invention, the cathode side current collector suitable for an electrochemical reducing environment may be a stamped plate made of stainless steel but not limited thereto. In an embodiment, the anode side current collector suitable for an electrochemical oxidizing environment may be a stamped plate made of Titanium but not limited thereto. The bi-polar plate and/or the current collector may be coated with one or more coatings to provide corrosion resistance and electrical conductivity. The electrodes may either be coated on the membrane to form a Membrane Electrode Assembly or they may be coated onto the Gas Diffusion Layers. The Gas Diffusion Layer may be made of one or more materials suitable for PEM anode and cathode environments including, but not limited to titanium, and carbon for the cathode.

In an embodiment of the invention, a PEM electrolysis cell, is provided, which is a device for cation exchange water electrolysis. The PEM electrolysis cell includes a membrane, which is a barrier separating anode and cathode streams, enabling ionic exchange between those streams, and preventing gas cross-over and electronic conduction. It further includes electrodes, which are layers of conducting material on either side of said membrane and enabling electro-chemical reactions to occur. The cell may also include gas diffusion layers to facilitate the transport of species to and from the electrodes. The electrodes can be coated onto the membrane creating a membrane-electrode assembly. Alternatively, the electrodes can be coated onto the gas diffusion layers. The PEM electrolysis cell includes a cell frame, which is a frame made of a plastic material including means for flow control and which is molded over the membrane by applying an insert molding procedure and supplied with cell inlet and cell outlet features that direct the anode and cathode flow to pass over respective electrodes on both sides of the membrane. The cell also includes a bi-polar plate, which is a plate made of electrically conducting material and of appropriate size and shape to separate streams of anode and cathode fluids passing over the electrodes. The bi-polar plate is also arranged to couple two different electrolysis cells including means for inter-connecting the electrodes. The bi-polar plate may be manufactured to include a current collector as part of a single plate structure rather than making those components of multiple plates. The cell includes a gasket for joining the electrolysis cell to another electrolysis cell and which is molded over the bi-polar plate by applying an insert molding procedure and such that it can be joined with said cell frame without inhibiting anode and cathode flow in and out of the electrolysis cell. The cell frame and the gasket are configured in such a way that when one electrolysis cell is joined together with another electrolysis cell, the anode cell inlet features of all such joined together cells are merged into a single anode inlet manifold, the anode outlet features of all cells are merged into a single anode outlet manifold and likewise, cathode inlets of all cells are merged into a single cathode inlet manifold, and cathode outlets of all cells are merged into a single cathode outlet manifold. In an embodiment of the PEM electrolysis cell, the cell frame and the gasket are configured in such a way that the anode and cathode streams pass on either side of the membrane in a cross-flow configuration. In another embodiment of the PEM electrolysis cell, the frame and gasket are configured for the streams to co-flow. In an embodiment of the PEM electrolysis cell, the electrolysis cell is positioned in such a way that the flow direction of the anode and the cathode streams is approximately 45 degrees to the horizontal plane, whereby the separation of gaseous and liquid phases is facilitated.

In another embodiment of the invention, an AEM electrolysis cell is provided, which is a device for anion exchange water electrolysis. The cell includes the membrane described herein. It further includes the electrodes and may also include the gas diffusion layers facilitating the transport of gas away from the electrodes. The electrodes can be coated onto the membrane creating a membrane-electrode assembly. Alternatively, the electrodes can be coated onto the gas diffusion layers. The cell includes the cell frame and the means for flow control. The cell frame is molded over the membrane by applying an insert molding procedure. The cell frame includes cell inlet and cell outlet features that direct the anode and cathode flow to pass over respective electrodes on both sides of the membrane. The cell also includes the bi-polar plate. The bi-polar plate is arranged to couple two different electrolysis cells including means for inter-connecting the electrodes. The bi-polar plate may be manufactured to include a current collector as part of a single plate structure rather than making those components of multiple plates. The cell includes the gasket for joining the AEM electrolysis cell to another electrolysis cell and which is molded over the bi-polar plate using the insert molding procedure such that it can be joined with the cell frame without inhibiting anode and cathode flow in and out of the AEM electrolysis cell. The cell frame and the gasket are configured in such a way that when one electrolysis cell is joined together with another electrolysis cell, the anode cell inlet features of all such joined together cells are merged into a single anode inlet manifold, the anode outlet features of all cells are merged into a single anode outlet manifold and likewise, cathode inlets of all cells are merged into a single cathode inlet manifold, and cathode outlets of all cells are merged into a single cathode outlet manifold. In an embodiment of the AEM cell, the cell frame and the gasket are configured in such a way that the anode and cathode streams pass on either side of the membrane in a cross-flow configuration. In another embodiment, the frame and gasket are configured for the streams to co-flow. In an embodiment, the electrolysis cell is positioned so that the flow direction of the anode and the cathode streams is about 45 degrees to the horizontal plane, whereby the separation of gaseous and liquid phases is facilitated.

In another embodiment of the invention, a PEM fuel cell is provided, which is an electrochemical device for power production with a PEM. The cell includes the membrane described herein, which for the PEM fuel cell is a barrier separating anode and cathode streams, enabling ionic exchange between the streams, and preventing gas cross-over and electronic conduction. The cell further includes the electrodes, which are layers of conducting material on either side of the membrane and enabling electrochemical reactions to occur. The cell also includes the gas diffusion layers facilitating the transport of species to and from the electrodes. The electrodes can be coated onto the membrane creating a membrane-electrode assembly. Alternatively, the electrodes can be coated onto the gas diffusion layers. The PEM fuel cell includes a cell frame and includes means for flow control, and which is molded over the membrane using the insert molding procedure. The frame includes the cell inlet and cell outlet features that direct the anode and cathode flow to pass over respective electrodes on both sides of the membrane. The cell also includes the bi-polar plate. The bi-polar plate is arranged to couple two different electrolysis cells including means for inter-connecting said electrodes. The bi-polar plate may be manufactured to include a current collector as part of a single plate structure rather than making those components of multiple plates. The cell includes the gasket for joining the PEM fuel cell to another PEM fuel cell. The gasket is molded over the bi-polar plate using the insert molding procedure described. The gasket can be joined with the cell frame without inhibiting anode and cathode flow in and out of the fuel. The cell frame and the gasket are configured in such a way that when one PEM fuel cell is joined together with another PEM fuel cell, the anode cell inlet features of all such joined together cells are merged into a single anode inlet manifold, the anode outlet features of all cells are merged into a single anode outlet manifold and likewise, cathode inlets of all cells are merged into a single cathode inlet manifold, and cathode outlets of all cells are merged into a single cathode outlet manifold. In an embodiment, the cell frame and the gasket are configured in such a way that the anode and cathode streams pass on either side of the diaphragm in a cross-flow configuration. In another embodiment, the frame and gasket are configured for the streams to co-flow. While the fuel cell does not include multiphase flow as is ordinarily the case for the electrolysis cell, the PEM fuel cell may nevertheless be configured to establish one or more flow options, such as for cross-flow, co-flow, and counter-flow with respect to the anode and cathode fluids (gases).

In another embodiment of the invention, an AEM fuel cell is provided. The AEM fuel cell is an electrochemical device for power production with an AEM. The cell includes the membrane and the electrodes. The AEM fuel cell also includes gas diffusion layers facilitating the transport of gas away from the electrodes. The electrodes can be coated onto the membrane creating a membrane-electrode assembly. Alternatively, the electrodes can be coated onto the gas diffusion layers. The cell includes the cell frame including means for flow control and which is molded over the membrane using the insert molding procedure described. The frame includes the cell inlet and cell outlet features that direct the anode and cathode flow to pass over respective electrodes on both sides of the membrane. The cell also includes the bi-polar plate of appropriate size and shape to separate streams of anode and cathode fluids passing over the electrodes. The bi-polar plate is also arranged to couple two different electrolysis cells including means for inter-connecting the electrodes. The bi-polar plate may be manufactured to include the current collector as part of a single plate structure rather than making those components of multiple plates. The cell includes the gasket for joining the AEM fuel cell to another AEM fuel cell. The gasket is molded over the bi-polar plate using the insert molding procedure such that it can be joined with the cell frame without inhibiting anode and cathode flow in and out of the AEM fuel cell. The cell frame and the gasket are configured in such a way that when one AEM fuel cell is joined together with another AEM fuel cell, the anode cell inlet features of all such joined together cells are merged into a single anode inlet manifold, the anode outlet features of all cells are merged into a single anode outlet manifold and likewise, cathode inlets of all cells are merged into a single cathode inlet manifold, and cathode outlets of all cells are merged into a single cathode outlet manifold. In an embodiment, the cell frame and the gasket are configured in such a way that the anode and cathode streams pass on either side of the diaphragm in a cross-flow configuration. In another embodiment, the frame and gasket are configured for the streams to co-flow. While the fuel cell does not include multiphase flow as is ordinarily the case for the electrolysis cell, the AEM fuel cell may nevertheless be configured to establish one or more flow options, such as for cross-flow, co-flow, and counter-flow with respect to the anode and cathode fluids (gases).

In another embodiment of the invention, a membraneless AWE electrolysis cell is provided, which is another form of device for alkaline water electrolysis. The cell includes porous electrodes, which are layers of conducting material separated and attached to current collectors on either side of the cell and enabling electro-chemical reactions to occur. Electrolyte enters in the gap between the electrodes and flows through the electrodes transporting gas bubbles out of the cell. The gap between the electrodes may contain a structure to ensure the electrodes cannot touch. The electrode material can be any suitable material for carrying out alkaline water electrolysis reactions. The electrode structure and the flow of electrolyte between the electrodes is designed to facilitate bubble transfer out of the cell and prevent gas mixing in the cell by limiting bubbles from entering the gap between the electrodes. The cell includes a cell frame, which is a frame made of a plastic material including means for flow control and which may include the structure for preventing the electrodes from touching. The cell frame includes inlet and outlet features that allow the flow to enter between the electrodes and exit on the other side of the electrodes. The cell also includes a bi-polar plate. which is a plate made of electrically conducting material and of appropriate size and shape to separate streams of anode and cathode fluids passing over the electrodes. The bi-polar plate is also arranged to couple two different electrolysis cells including means for inter-connecting the electrodes. The bi-polar plate may be manufactured to include a current collector as part of a single plate structure rather than making those components of multiple plates. The cell includes a gasket for joining the electrolysis cell to another electrolysis cell. The gasket is molded over the bi-polar plate using the insert molding procedure such that it can be joined with the cell frame without inhibiting anode and cathode flow in and out of the membraneless electrolysis cell. The cell frame and the gasket are configured in such a way that when one electrolysis cell is joined together with one or more other electrolysis cells, the anode cell inlet features of all such joined together cells are merged into a single anode inlet manifold, the anode outlet features of all cells are merged into a single anode outlet manifold and likewise, cathode inlets of all cells are merged into a single cathode inlet manifold, and cathode outlets of all cells are merged into a single cathode outlet manifold. In an embodiment of the membraneless cell, the cell frame and the gasket are configured in such a way that the anode and cathode streams pass on either side of the electrodes set in a cross-flow configuration. In another embodiment, the frame and gasket are configured for the streams to co-flow. In an embodiment, the electrolysis cell is positioned so that the flow direction of the anode and the cathode streams is about 45 degrees to the horizontal plane, whereby the separation of gaseous and liquid phases is facilitated.

The invention also provides an embodiment of an insert molding procedure for making an electrolysis cell or a fuel cell, including optional stacks of each. The method includes the steps of providing a membrane/diaphragm enabling ionic exchange between said streams and preventing gas cross-over and electronic conduction, attaching or placing in close proximity electrodes to either side of the diaphragm, molding a cell frame over the membrane/diaphragm in a manner that provides structural support and directing anode and cathode streams to pass along the electrodes attached to different sides of the membrane/diaphragm, providing a bi-polar plate for separating anode and cathode streams and providing contact between two electrodes attached to neighboring membranes/diaphragms, and establishing electrical contacts in the bi-polar plate, such as by making indentations in the bi-polar plate, to enable electrical contacts between anode and cathode side of adjacent electrolysis cells. The method may further include the steps of molding a gasket over the bi-polar plate with a shape that fits the cell frame and making the electrolysis cell by joining the bi-polar plate with the membrane/diaphragm and electrodes whereby the cell frame comes in contact with the gasket and the diaphragm sandwiches the electrodes with the bi-polar plate, which produces a single electrolysis cell that can be incorporated into the electrolysis stack. The method may also include the step of configuring the cell frame to enable a cross-flow of the anode and cathode streams along the electrode surfaces attached to different sides of the diaphragm. A co-flow may also be established.

The method may further include the step of positioning the electrolysis cell in such a way that the flow direction of the anode and cathode streams is approximately 45 degrees to the horizontal plane, whereby the separation of gaseous and liquid phases is facilitated. The method may also include the step of joining a plurality of electrolysis cells together in a manner that provides for a common anode inlet manifold into the joined cells and a common anode outlet manifold from the joined cells and likewise provides for a common cathode inlet manifold and a common cathode outlet manifold for the joined cells, whereby the electrolysis stack is produced. The method may also include the step of placing the membrane/diaphragm into a temperature-controlled cold plate inside the insert mold prior to the application of the molding procedure to prevent damage to the membrane/diaphragm. As noted, the membrane/diaphragm may be over molded into the cell frame. The bi-polar plate may be overmolded into the gasket (seal ring). Alternatively, the membrane/diaphragm may be over molded into the gasket (seal ring) and the bi-polar plate may be over molded into the cell frame. The bipolar plate may be a full diameter bipolar plate with over molded stack and gasket seals. Alternatively, the bipolar plate may be the only active area with over molded seal ring/gasket. The insert molding procedure may be used to form various cell configurations including PEM and AEM AWEs as well as PEM and AEM fuel cells. Optionally, the AWE electrolysis cells may be formed without a diaphragm.

Reductions in labor cost can be realized through reduction in part counts required for assembly of an electrolysis/fuel cell, through the highly automated and highly scalable method of manufacture. Additionally, the design allows for ease of assembly through a highly symmetric design allowing for a low sensitivity to orientation of cell frames and seal rings during electrolysis cell and stack assembly. Stack assembly is facilitated by tactile positive interlocking of cell components in the correct orientation. The cell design is especially advantageous for a zero-gap or generally a minimum gap electrolyzer design as well as a more traditional gapped design. In addition to that, the novel cell is suitable to operate at a wide range of pressures. The method of making the cell of the present invention is competitive in mass production of inexpensive devices for water electrolysis and fuel cells. The cell can also be competitive in production of large volumes of hydrogen at reduced costs.

### BRIEF DESCRIPTION OF THE DRAWINGS

FIG. 1 is a top perspective view of a molded cell frame of an AWE embodiment of the present invention for a cross flow configuration.

FIG. 2 is a top perspective view of a molded cell frame of the AWE embodiment of the present invention for a co-flow configuration.

FIG. 3 is a top perspective view of the AWE embodiment of the present invention with a cell frame molded over the diaphragm.

FIG. 4 is a top perspective view of a bi-polar plate of the AWE embodiment of the present invention.

FIG. 5 is a top perspective view of the AWE embodiment of the present invention with a gasket separating different stack cells in a cross-flow configuration.

FIG. 6 is a top perspective view of a gasket molded over the bi-polar plate in a cross-flow configuration for the AWE embodiment.

FIG. 7 is a top perspective view of the gasket molded over the bi-polar plate in a co-flow configuration for the AWE embodiment.

FIG. 8 is a top perspective view of a cross-flow cell of the AWE embodiment of the present invention to be joined into a stack.

FIG. 9 is a top perspective view of a co-flow cell of the AWE embodiment of the present invention to be joined into a stack.

FIG. 10 is a top perspective view of two cells to be joined together into a stack for the AWE embodiment.

FIG. 11 is a top view of tilted alignment of the cross-flow cell relative to gravity for the AWE embodiment.

FIG. 12 is a cross sectional perspective view of an electrolysis stack including a plurality of electrolysis cells of the AWE embodiment of the present invention with a cross flow design.

FIG. 13 is a cross sectional perspective view of a cell of the present invention representative of the electrolysis cells and fuel cells described herein.

FIG. 14 is a simplified representation of an electrolysis stack including a plurality of electrolysis cells of the AWE embodiment of the present invention with end plates arranged for pass-through fluid flow.

FIG. 15 includes FIGS. 15A and 15B. FIG. 15A is a perspective view of the inside of an example inlet end plate of the AWE embodiment of the present invention for the FIG. 14 stack. End plates for other cell types described herein are substantially the same.

FIG. 15B is a perspective view of the outside of the example inlet end plate of the AWE embodiment of the present invention for the FIG. 14 stack.

FIG. 16 includes FIGS. 16A and 16B. FIG. 16A is a perspective view of the inside of an example outlet end plate of the AWE embodiment of the present invention for the FIG. 14 stack.

FIG. 16B is a perspective view of the outside of the example inlet end plate of the AWE embodiment of the present invention for the FIG. 14 stack.

FIG. 17 is a simplified representation of an electrolysis stack including a plurality of electrolysis cells of the AWE embodiment of the present invention with end plates arranged for return fluid flow.

FIG. 18 includes FIGS. 18A and 18B. FIG. 18A is a perspective view of the inside of an example inlet end plate of the AWE embodiment of the present invention for the FIG. 17 stack. End plates for other cell type stacks described herein are substantially the same.

FIG. 18B is a perspective view of the outside of the example inlet end plate of the AWE embodiment of the present invention for the FIG. 17 stack.

FIG. 19 includes FIGS. 19A and 19B. FIG. 19A is a perspective view of the inside of an example end plate of the AWE embodiment of the present invention for use with the inlet end plate of FIGS. 18A and 18B.

FIG. 19B is a perspective view of the outside of the example end plate of FIGS. 18A and 18B.

FIG. 20 is a cross sectional representation of a 7-layer Membrane Electrode Assembly (MEA).

FIG. 21 is a cross sectional representation of a 5-layer MEA.

FIG. 22 is a cross sectional representation of a 3-layer MEA.

FIG. 23 is a cross sectional representation of a cell of the invention with an optional gapped cell configuration.

FIG. 24 is a cross sectional representation of a cell of the invention with an optional zero-gap/minimal-gap configuration.

FIG. 25 is a cross sectional representation of a cell of the invention with an optional membraneless configuration.

FIG. 26 is a cross sectional representation of an optional overmolding system for reducing molding stress on the diaphragm/membrane.

FIG. 27 is a top perspective view of an optional construction of the cell of the present invention with the diaphragm/membrane and the bipolar plate switching positions.

FIG. 28 is a top perspective cross sectional view of the cell of FIG. 27.

FIG. 29 is a top perspective view of a stack of a plurality of the cells of FIG. 27.

FIG. 30 is a top perspective cross sectional view of the stack of FIG. 29.

FIG. 31 is a perspective view of a cell stack with protective outer shell.

FIG. 32 is a cross section perspective view of the stack of FIG. 31.

### DETAILED DESCRIPTION OF SEVERAL EMBODIMENTS OF THE INVENTION

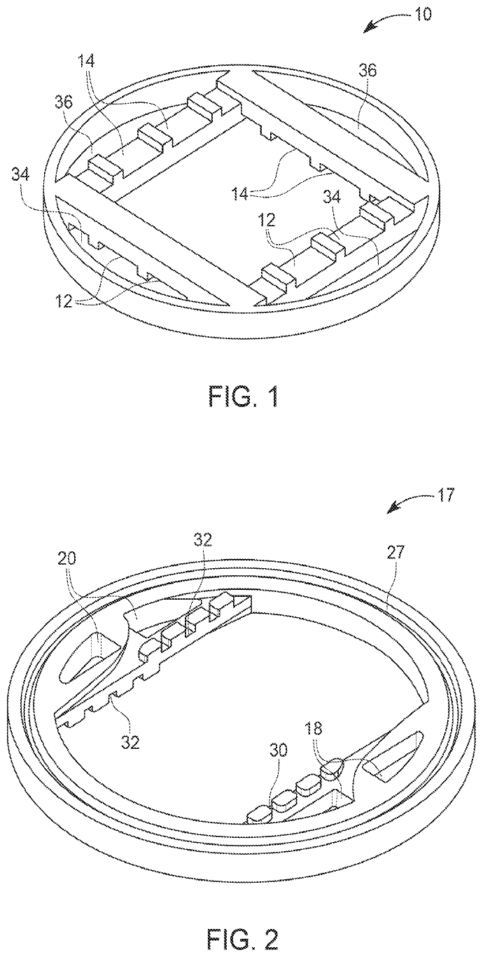

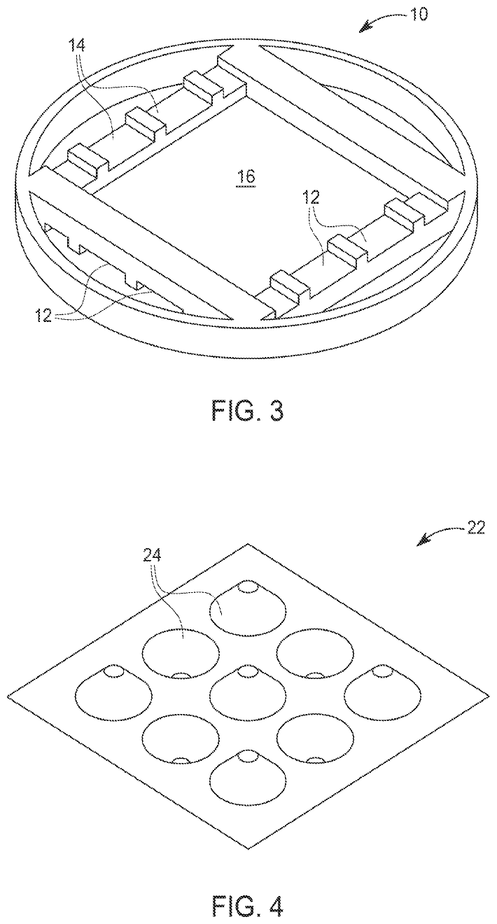

A cell frame (10) of an AWE embodiment of the electrolyzer cell of the present invention with a cross-flow construct is illustrated in FIGS. 1, 3, 8, 10, 11, and 12. In this embodiment, a flow control mechanism of the cell is implemented as an outside cylindrical shell of the frame of appropriate width to withstand the pressure difference between the pressure inside the frame and ambient pressure outside. The cell frame (10) includes cross flow arranged inlets (12) and outlets (14) for anode and cathode streams, and cross flow inlet manifolds (34) and outlet manifolds (36). A square area inside the cell frame (10) holds a diaphragm (16) separating anode and cathode streams associated with an anode electrode and a cathode electrode represented generically by first electrode (42) and second electrode (44) in several figures. The flow control mechanism incorporated into the cross flow cell frame (10) include features providing structural support and directing the flow are implemented as the cell inlets (12) and the cell outlets (14). They are positioned to direct the anode and cathode flow streams to the opposite sides of the diaphragm (16) associated with electrodes 42 and 44. In addition to that, they are configured to provide a cross-flow pattern of the two streams. FIG. 3 shows the cell frame (10) over-molded on the diaphragm (16), which is an important distinction of this embodiment of the invention.

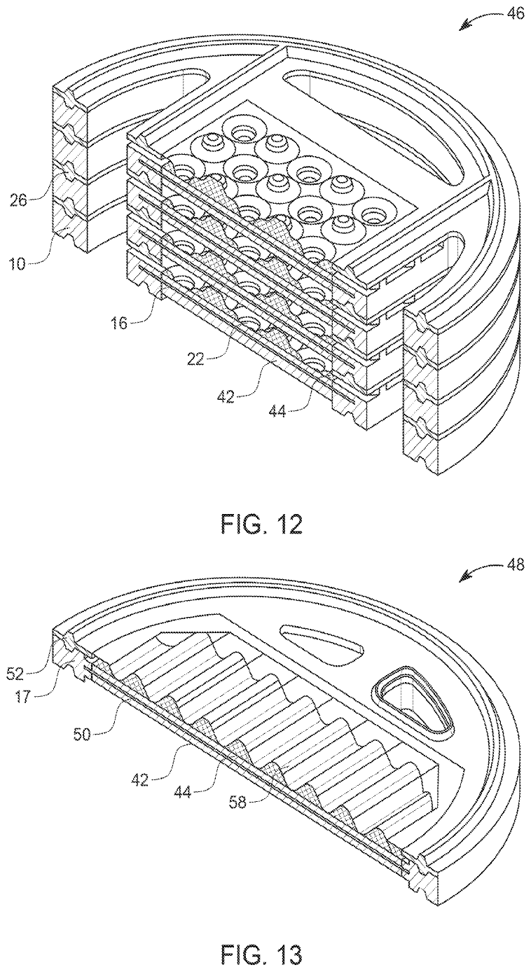

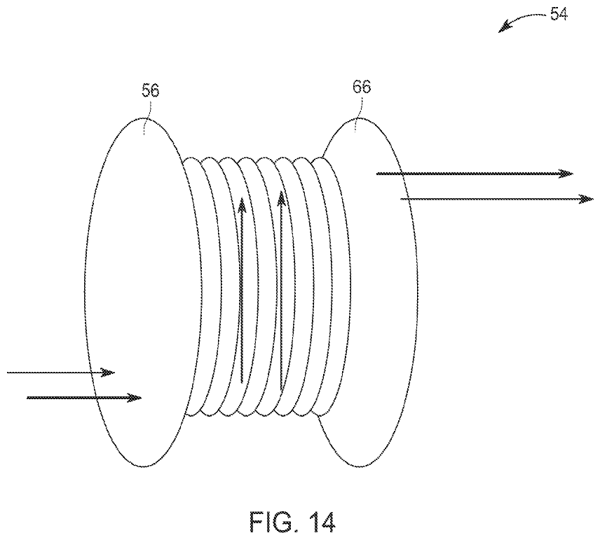

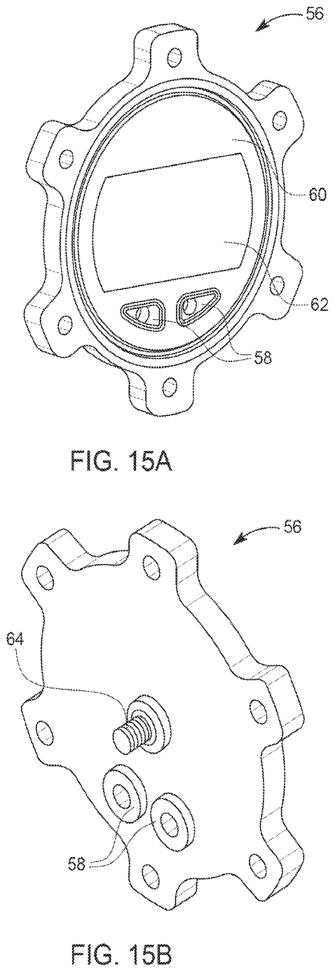

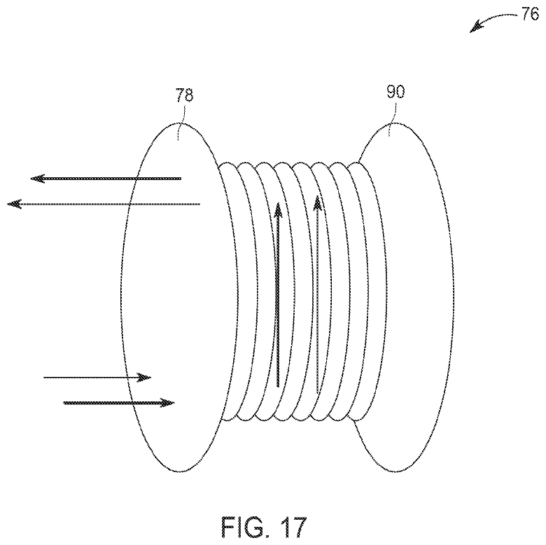

The shape of the cell inlets (12) and the outlets (14) provide a structural support for a bi-polar plate cross flow gasket (26) of a cross flow bi-polar plate (22). The gasket (26) itself serves as a sealing around the bipolar plate (22) to separate anode and cathode areas as well as sealing of the gas manifolds which direct anode and cathode flow in and out of a stack of cells such as shown in FIG. 12. A joined arrangement of two cross flow cells is shown in FIG. 10. In addition to that, the shapes of the inlets (12) and the outlets (14) provide a structural support for the bi-polar plate gasket (26) by means of indentations (24). Additionally, the flow control mechanism includes gas manifolds (34) and (36) and external walls of the pressure vessel of the electrolysis stack. The cell frame (10) and the gasket (26) are manufactured using electrically insulating materials, which may be polymeric materials but not limited thereto, and which provide electrical isolation of exterior surfaces of a stack of electrolyzer cells. It is to be noted that end plates shown and described with respect to FIGS. 15A, 15B, 16A, 16B, 18A, 18B, 19A, and 19B serve as caps on ends of a stack of electrolyzer cells such as stack 54 of FIG. 14 and stack 76 of FIG. 17, to provide compression to the cells and gaskets (26), thereby forming a gas-tight system.

A cell frame (17) of an electrolyzer cell of the present invention for a co-flow configuration of the AWE embodiment with a co-flow construct is shown in FIG. 2. The cell frame (17) includes co-flow arranged inlets (30) and outlets (32) for anode and cathode streams, and co-flow inlet manifolds (18) and outlet manifolds (20). A truncated oval area inside the cell frame (17) holds a co-flow diaphragm (50) separating anode and cathode streams associated with an anode electrode and a cathode electrode represented generically by first electrode (42) and second electrode (44) in several figures. The flow control mechanism incorporated into the co-flow cell frame (17) includes features providing structural support and directing the flow are implemented as the cell inlets (30) and the cell outlets (32). They are positioned to direct the anode and cathode flow streams to the opposite sides of the diaphragm (50) associated with electrodes 42 and 44. In addition to that, they are configured to provide a co-flow pattern of the two streams. FIG. 2 shows the cell frame (17) over-molded on the diaphragm (50), which is an important distinction of this embodiment of the invention.

The shape of the cell inlets (30) and the outlets (32) provide a structural support for a bi-polar plate co-flow gasket (52) of a co-flow bi-polar plate (38). The gasket (52) itself serves as a sealing around the bipolar plate (38) to separate anode and cathode areas as well as sealing of the gas manifolds which direct anode and cathode flow in and out of a stack of cells. The cell frame (17) and the gasket (52) are manufactured using electrically insulating polymer materials, which provide electrical isolation of exterior surfaces of a stack of the electrolyzer cells.

The anode and cathode inlet and outlet manifolds are represented by the inlet manifold elements (18/34) and the respective outlet manifold elements (20/36). The flow in the inlet manifold (18/34) is directed into cell inlets (12/30) and the flow from the cell outlets (14) is merged into the outlet manifold (20). Cell inlets (12/30) and outlets (14/32) are positioned such that the anode and cathode streams pass across the surface of the diaphragm (16/50) in a cross-flow pattern for the combination of Dec. 14, 2016 and in a co-flow pattern for the combination of 30/32/50. For example, the anode stream can enter from the bottom-left and exit at the top-right while the cathode stream will go from bottom-right to top left.

An embodiment of the crossflow bi-polar plate (22) is shown in FIG. 4. An interconnector to interconnect the electrodes (16) on the cathode and anode sides may be implemented as conical indentations (24) of the crossflow bi-polar plate (22). The indentations (24) provide for electrical interconnect between the anode and the cathode electrodes (42/44). In this implementation, the indentations (24) are produced by applying a sheet metal stamping procedure followed by electroplating. Alternatively, a plate of suitable material could be stamped without electroplating. In the case of a cross flow depicted in FIG. 4, the indentations (24) can be of a conical or semi-spherical shape with peaks of some indentations contacting or substantially contacting the anode of one cell and with peaks of others contacting or substantially contacting the cathode of an adjacent cell. In the case of a co-flow configuration, line indentations or ridges (40) are used, which can be produced by a roller die or other means. For the co-flow ridges (40), peaks of some indentations contacting or substantially contacting the anode of one cell and with valleys of others contacting or substantially contacting the cathode of an adjacent cell.

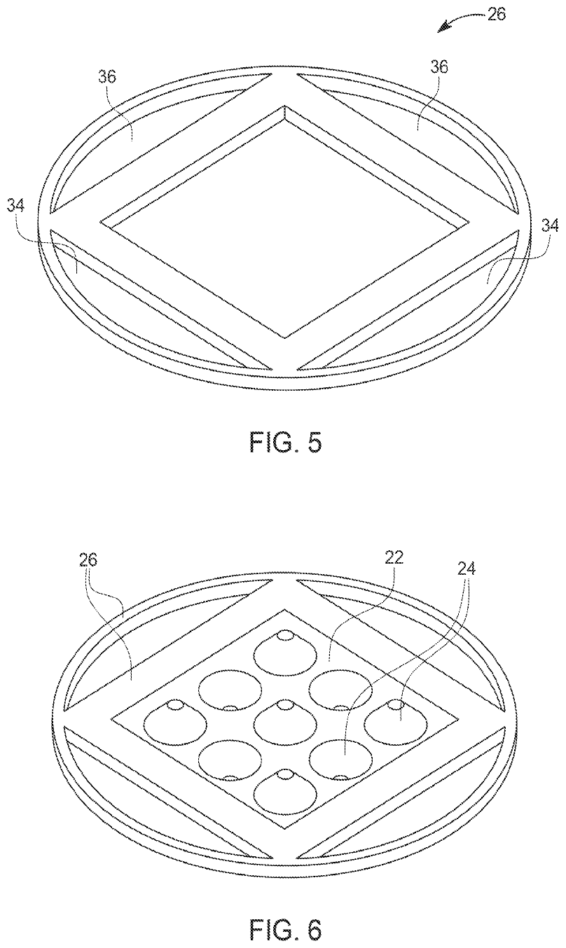

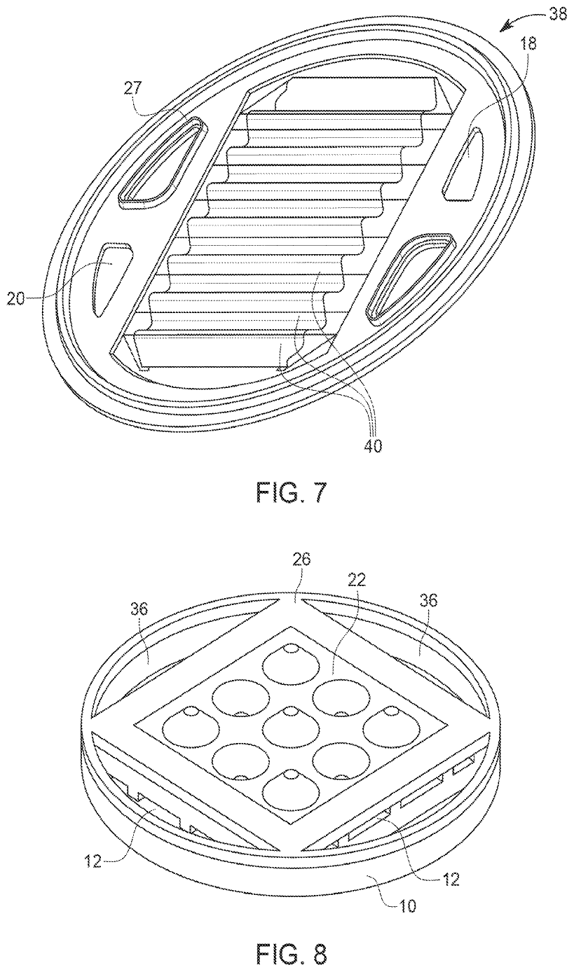

An alternative embodiment of the gasket (26) molded over the cross flow bi-polar plate (22) is shown in FIG. 5, which also includes the inlet manifolds (34) and outlet manifolds (36) directing the anode and cathode streams into the square section of the cell frame (10) where the diaphragm (16) is located. The bi-polar plate (22) with the over-molded gasket (26) is shown in FIG. 6 with the gasket (26) shown alone in FIG. 7.

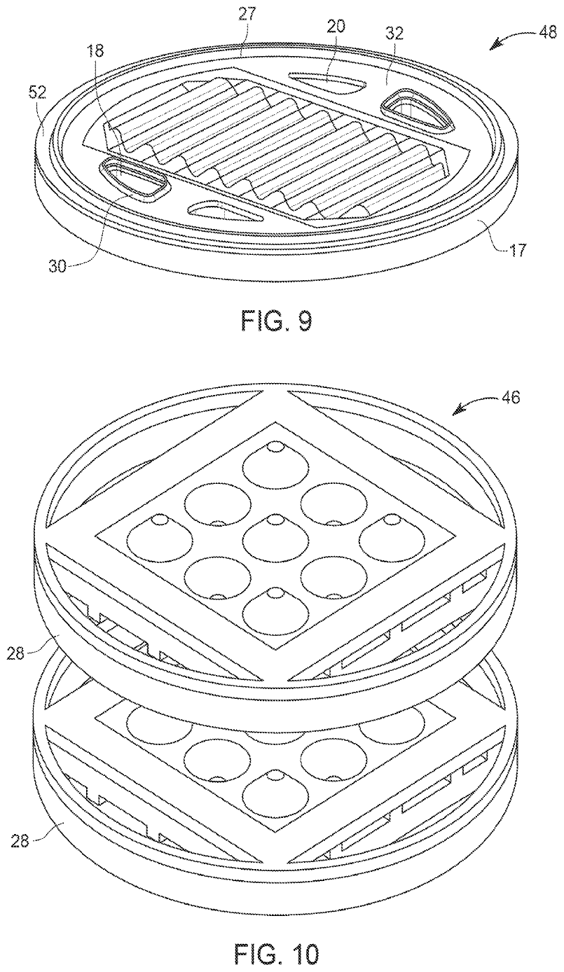

A cross flow electrolysis cell (28) of FIG. 8 shows the cell frame (10) over-molded on the diaphragm (16) and the bi-polar plate (22) with over-molded gasket (26) Also shown are the outlet manifolds (36) and the anode and cathode inlets (12) into the square area of the cell frame (10), which holds the diaphragm (16). FIG. 9 shows an embodiment of a co-flow electrolysis cell frame (48) where a groove (27) to hold the gasket (52) in-place is shown. When the co-flow cell frame (17) is joined with the gasket (52), the inlet manifold (18) is joined with the respective cell inlet (30) and each cell outlet (32) is merged into the respective outlet manifold (20).

An electrolysis cell combination in a cross flow stack (46), which includes the diaphragm (16), cell frame (10), bi-polar plate (22), and the gasket (26) is shown in FIG. 10, which illustrates two cross flow electrolysis cells (28) positioned together, one on top of the other to be joined into the stack (46).

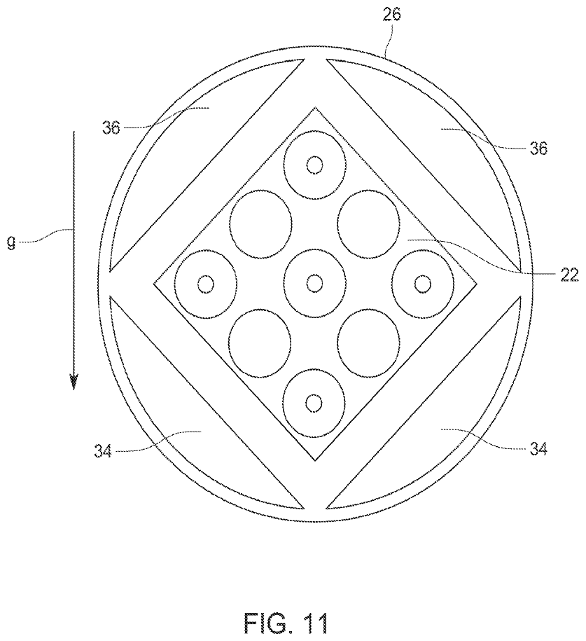

In an embodiment of the invention, the positioning of the cross flow stack (46) during operation when each cross flow cell (28) of the stack (46) is oriented horizontally such that the manifold inlets (34) and manifold outlets (36) are aligned at about 45 degrees to the force of gravity (g) is illustrated in FIG. 11. The arrow shown in FIG. 11 represents the direction of gravity (g) to highlight the orientation of the cell (28) with respect to gravity. That is, the arrow highlights orientation for facilitating bubble movement in the cell (28) due to bubble buoyancy. This facilitates the collection and removal of gases from respective flow streams. The same can be done for stack (48) comprising co-flow cells (17).

FIG. 13 provides a cross-sectional view of an over molded cell (48) of the present invention. Specifically, FIG. 13 shows the membrane/diaphragm (50), the anode electrode (42), which may be any of an AWE anode electrode, a PEM electrolyzer anode electrode, an AEM electrolyzer anode electrode, a PEM fuel cell anode electrode, or an AEM fuel cell anode electrode, the cathode electrode (44), which may be any of an AWE cathode electrode, a PEM electrolyzer cathode electrode, an AEM electrolyzer cathode electrode, a PEM fuel cell cathode electrode, or an AEM fuel cell cathode electrode. The overmolded cell (48) further includes the bipolar plate (38), the flow field (58), the cell frame (17), and the gasket (52). The AWE electrolyzer cell, the PEM and AEM electrolyzer cells, and the PEM and AEM fuel cells have all been described herein. Their structures are all substantially as shown in FIG. 13, with the AWE cell including a diaphragm as defined herein, the PEM and AEM electrolyzer cells including a membrane as defined herein, with optional gas diffusion layers, and the PEM and AEM fuel cells including a membrane as defined herein with the required gas diffusion layers. Generally, then, it is noted that a PEM electrolysis cell of the present invention is similar in structure to the other electrochemistry cells and can be easily constructed using the over molding of the present invention to create a novel cell structure with plastic molding easily manufactured that replaces individual metal parts that must be assembled. Further, drop-in replacements for the membrane or diaphragm and the electrodes are similarly placed for all cell configurations. The bipolar plates serve the same function and are similarly constructed and placed.

An embodiment of an electrolysis stack or fuel cell stack (54) including a plurality of cells joined together in compression by inlet end plate assembly (56) and opposing outlet end plate assembly (66) for a pass-through fluid flow stack is shown in FIG. 14. As shown in FIGS. 15A and 15B, the inlet end plate assembly (56) includes inlet end plate inlets (58) for the anode and cathode streams. The inlets (58) are arranged to be at a bottom portion of the assembly (56) but that orientation is not limiting. The assembly (56) also includes an inlet end plate liner (60) and an inlet end plate current collector (62). An inlet end plate power lug (64) is used to join the assembly (56) to a first cell of the stack (54).

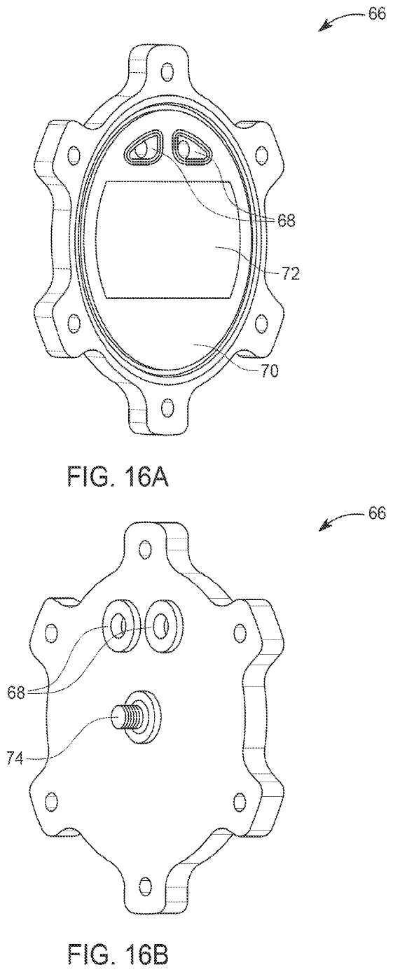

As shown in FIGS. 16A and 16B, the outlet end plate assembly (66) includes outlet end plate outlets (68) for the anode and cathode streams. The outlets (68) are arranged to be at a top portion of the assembly (66) but that orientation is not limiting. The assembly (66) also includes an outlet end plate liner (70) and an outlet end plate current collector (72). An outlet end plate power lug (74) is used to provide electrical conductivity through the end plate assembly (66) to the last cell of the stack (54).

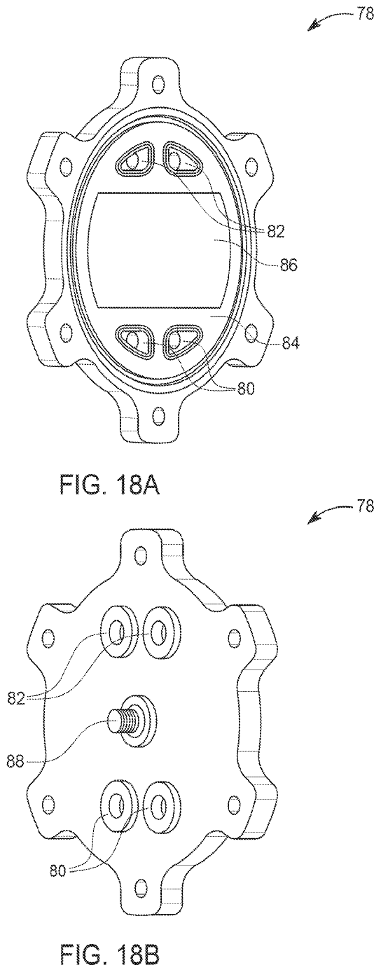

An embodiment of an electrolysis stack (76) including a plurality of cells joined together in compression by ported end plate assembly (78) and opposing closed end plate assembly (90) for a return fluid flow stack is shown in FIG. 17. As shown in FIGS. 18A and 18B, the ported end plate assembly (78) includes ported end plate inlets (80) for the anode and cathode streams. The inlets (80) are arranged to be at a bottom portion of the ported end plate assembly (78) but that orientation is not limiting. The assembly (78) also includes ported end plate outlets (82) for the anode and cathode streams. The outlets (82) are arranged to be at a top portion of the assembly (78) but that orientation is not limiting. The assembly (78) further includes a ported end plate liner (84) and a ported end plate current collector (86). A ported end plate power lug (88) is used to provide electrical conductivity through the end plate assembly (78) to the first cell of the stack (76).

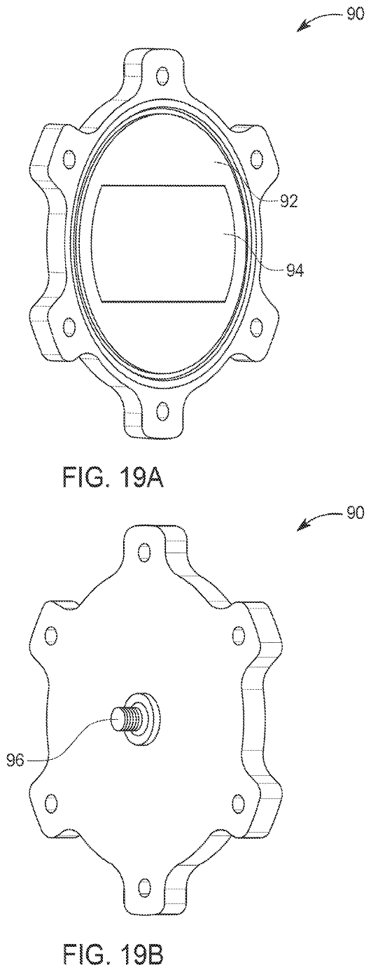

As shown in FIGS. 19A and 19B, a closed end plate assembly (90) includes a closed end plate liner (92) and a closed end plate current collector (94). A closed end plate power lug (96) is used to removably provide electrical conductivity through the end plate assembly (90) to a last cell of the stack (76).

The material selected to make the end plates must have sufficient structural integrity to hold a stack in compression. For example, it may be made of structural metal but not limited thereto. The power lug is chosen of a material that is electrically conductive containing low ohmic resistance and sufficient structural integrity to maintain stack compression. The inlets and the outlets are each made of an electrically conductive material, such as metal, having low ohmic resistance. In one embodiment, those components may be made completely of plastic with plastic threads. In a second embodiment, the inlets and the outlets include flange/face seal connections. In a third embodiment, the inlets and the outlets are made as insert-molded parts containing a metal structure with metal threads, with an electrically insulating and corrosion-resistant sleeve around the metal structure.

The liners of the assemblies may optionally be added to one or more of the end plates. The liners may be injection-molded insulators arranged to isolate the end plates from the electrical potential of the stack and the anode and cathode streams. That optional isolation enables the use of less expensive materials, i.e., lower corrosion resistance material, for manufacture of the end plates. The liner may be made of a non-conductive material, such as a non-metallic material selected to withstand the pressures and flows expected in the performance of a stack. While the invention will perform satisfactorily without them, isolation of the end plates such as with the liners, and electrical insulation of the cell and gasket materials, provide a higher level of built-in safety for the stack.

The end plates may further optionally include the current collectors as integrated current collectors forming a part of the end plates rather than a separate component of a stack. The current collector is made of an electrically conductive material with low ohmic resistance. The current collector may be formed directly to a face of the interior surface of the end plate or removably coupled thereto. The current collector is arranged to conduct current from the anode and cathode in the cell frame. Specifically, one end of the stack has a current collector that conducts from an anode of an adjacent cell. The opposite end plate has a current collector that conducts current from the cathode of the adjacent cell.

A PEM electrolyzer cell version of the present invention represented in FIGS. 13, 20 and 21, includes a cell frame (10/17), a bipolar plate (38), an optional first gas diffusion layer (100), a membrane (50), and an optional second gas diffusion layer (102). When a plurality of the PEM electrolyzer cells are joined together into a PEM stack generally represented by examples in FIGS. 12 and 14, the construction of the stack includes a first end plate (56), a plurality of PEM cells, and then a second end plate (66), wherein the first end plate (56) and the second PEM end plate (66) contain the plurality of PEM cells therebetween. The PEM electrolyzer cell may be configured for cross flow or co-flow in the manner described in the configurations of the AEW cell embodiment above with the cross-flow configuration (10) and the co-flow configuration (17).

An AEM electrolyzer cell version of the present invention represented in FIGS. 13, 20, and 21 includes a cell frame (10/17), a bipolar plate (38), an optional first gas diffusion layer (100), a membrane (50), and an optional second gas diffusion layer (102). When a plurality of the AEM electrolyzer cells are joined together into AEM stack generally represented in FIGS. 12 and 14, the construction of the stack includes a first end plate (56), a plurality of AEM cells, and then a second end plate (66), wherein the first end plate (56) and the second end plate (66) contain the plurality of AEM cells therebetween. The AEM electrolyzer cell may be configured for cross flow or co-flow in the manner described in the configurations of the AEW cell embodiment above with the cross-flow configuration (10) and the co-flow configuration (17).

With continuing reference to the alternative embodiments of the invention of a PEM fuel cell and an AEM fuel cell as previously defined herein and generally represented in FIG. 13, those two cell types are also formed with an overmold construction with the cell frame options as have been described herein. The PEM fuel cell version of the present invention represented in FIGS. 13, 20 and 21, includes a cell frame (10/17), a bipolar plate (38), a first gas diffusion layer (100), a membrane (50), and a second gas diffusion layer (102). When a plurality of the PEM fuel cells are joined together into a PEM stack generally represented by examples in FIGS. 12 and 14, the construction of the stack includes a first end plate (56), a plurality of PEM cells, and then a second end plate (66), wherein the first end plate (56) and the second end plate (66) contain the plurality of PEM cells therebetween. The PEM fuel cell may be configured for cross flow or co-flow in the manner described in the configurations of the AEW cell embodiment above with the cross-flow configuration (10) and the co-flow configuration (17).

The AEM fuel cell version of the present invention represented in FIGS. 13, 20, and 21 includes a cell frame (10/17), a bipolar plate (38), a first gas diffusion layer (100), a membrane (50), and a second gas diffusion layer (102). When a plurality of the AEM fuel cells are joined together into AEM stack generally represented in FIGS. 12 and 14, the construction of the stack includes a first end plate (56), a plurality of AEM cells, and then a second end plate (66), wherein the first end plate (56) and the second end plate (66) contain the plurality of AEM cells therebetween. The AEM fuel cell may be configured for cross flow or co-flow in the manner described in the configurations of the AEW cell embodiment above with the cross-flow configuration (10) and the co-flow configuration (17).

The AWE cell, the PEM cell, the AEM cell, and the PEM fuel cell, and the AEM fuel cell are manufactured with the following primary steps of an insert molding procedure or method of the invention. First, the membrane/diaphragm is over-molded to form the cell frame in the same way as described above to make the AWE cell. The membrane can be coated with catalyst to form a catalyst coated membrane (CCM) and then over-molded to form the cell frame. Alternatively, the catalyst can be coated onto a suitable gas diffusion layer (GDL) which is generally a porous carbon structure for the cathode and titanium mesh or titanium foam for the anode. The bipolar plate/gasket assembly is then formed by the same over-molding method used for AWE. The bipolar plate/current collector piece is formed in the same manner as for the AWE electrolyzer. The bipolar plate material can be any suitable material such as titanium and can be coated with platinum to act as a recombination catalyst. The end plates are identical to the AWE electrolyzer. The cells are assembled in the following sequence: bipolar plate/gasket, GDL, membrane, GDL where either the GDL or the membrane can contain the electrode catalyst. Finally, in order to produce a stack comprising any of the cells described, the cells can be assembled into a stack in the following sequence: first end plate, cell 1, cell 2, . . . cell n, second end plate.

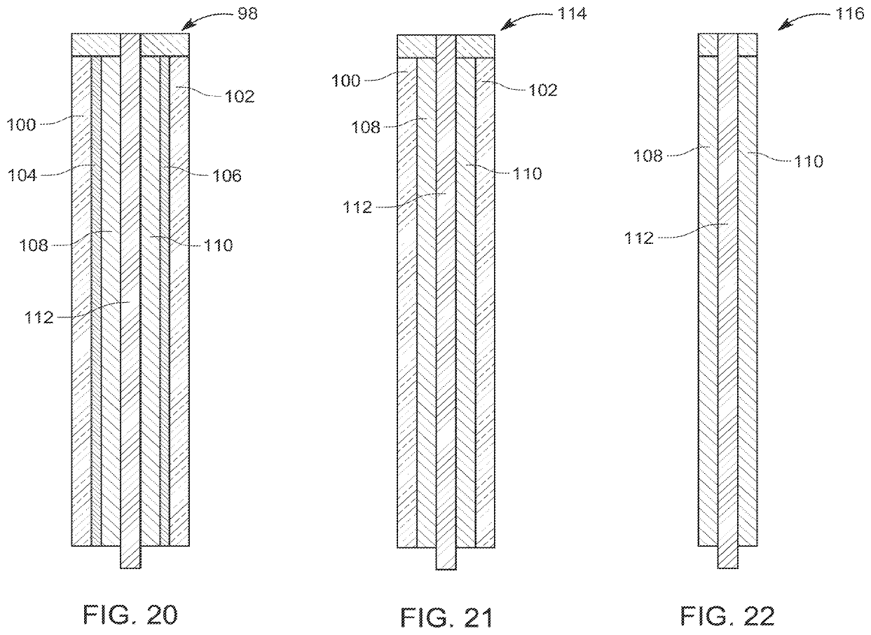

The cells of the present invention may have different layer composition within the overmolded cell frame construction described selected as a function of desired performance. Generic versions of the cells described herein are each referred to as a Membrane Electrode Assembly (MEA). FIG. 20 shows a 7-layer MEA (98) comprising a first Gas Diffusion Layer (GDL) (100) and a second GDL (102) as outer layers of the assembly, with a first microporous layer (104) and a second microporous layer (106) within the respective GDLs (100) and (102). Next in the 7-layer MEA(98) are an anode electrode (108) and a cathode electrode (110) about membrane (112). FIG. 21 shows a 5-layer MEA (114) comprising the first GDL (100), the anode electrode (108), the membrane (112), the cathode electrode (110), and the second GDL (102). The final example of a layered MEA is 3-layer MEA (116) shown in FIG. 22. It includes the anode electrode (108), the membrane (112), and the cathode electrode (110).

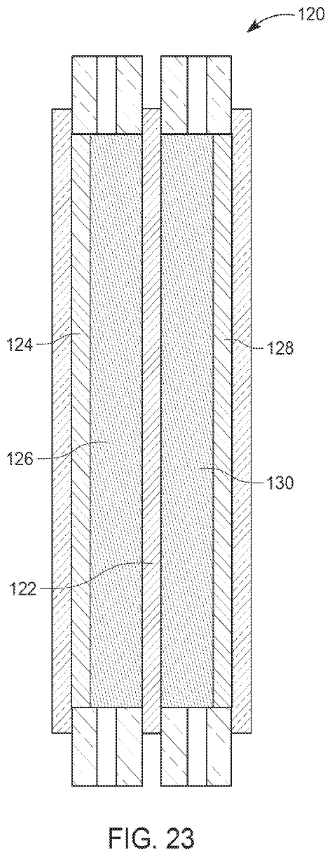

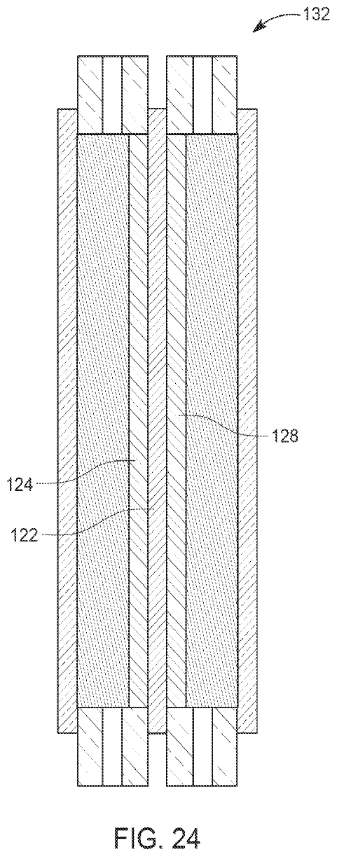

Another optional cell composition of the present invention is shown in FIG. 23. A gapped cell assembly (120) that is contained by overmolding is shown wherein electrodes are spaced from the membrane. Specifically, the assembly (12) includes diaphragm or membrane (122) spaced from an anode electrode (124) by anode fluid (126), and further spaced from a cathode electrode (128) by cathode fluid (130). In another optional cell composition shown in FIG. 24, a minimal-gap assembly (132), which may also be referred to as a zero-gap assembly (132) includes the membrane (122) directly adjacent to the anode electrode (124) and the cathode electrode (128).

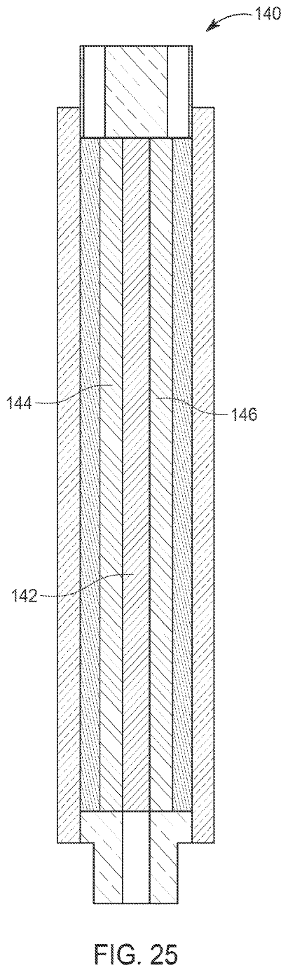

While the electrolyzer cells and fuel cells described herein have all been identified having either a diaphragm or a membrane. In an embodiment of the invention, the cell with overmolding may be membrane less or diaphragmless. FIG. 25 shows a construct of such a membraneless assembly (140), wherein a common electrolyte (142) separates an anode electrode (144) from a cathode electrode (146).

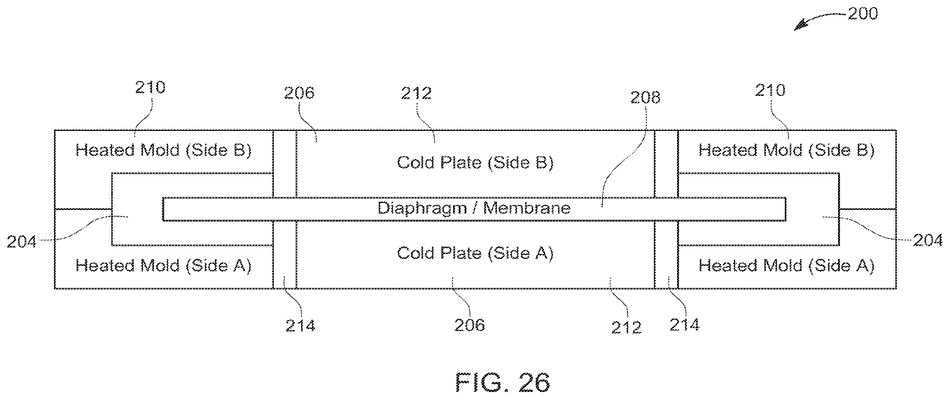

In manufacturing overmolded cells of the present invention, it is advantageous to secure the diaphragm/membrane during the overmolding process to limit flexing, distortion, or movement of the diaphragm/membrane. As shown in FIG. 26, a cell molding assembly (200), includes a mold (202) into which polymeric material (204) as the overmolding material is introduced in a hot, molten, fluid form. The mold (202) includes a retaining plate (206) arranged to constrain diaphragm/membrane (208) as the polymeric material flows in molten form and then also as it cools and shrinks. The retaining plate (206) includes a heated mold section (210) and a cold mold section (212). The heated mold section (210) maintains elevated temperature in the cavity where the polymeric material (204) is to flow until filling that cavity and completing overmolding of the cell assembly. The cold mold section (212) limits distortion of the diaphragm/membrane (208) as the hot polymeric material (204) flows. An insulator (214) limits temperature exchange between the heated mold section (210) and the cold mold section (212). The diaphragm/membrane is constrained in the cell frame when the cell frame is hot. As the molded polymer cools, it will contract due to thermal expansion and solidification, reducing tension on the diaphragm/membrane (208). The stress on the diaphragm/membrane (208) will be minimal during operating conditions when the cell is hot and expands because that diaphragm/membrane (208) was over molded into the cell component in that hot state. This aids in maintaining membrane alignment along with reducing possible distortion. It is noted that the bipolar plate can similarly be held in place during the over molding operation for alignment and to limit movement or distortion during molding.

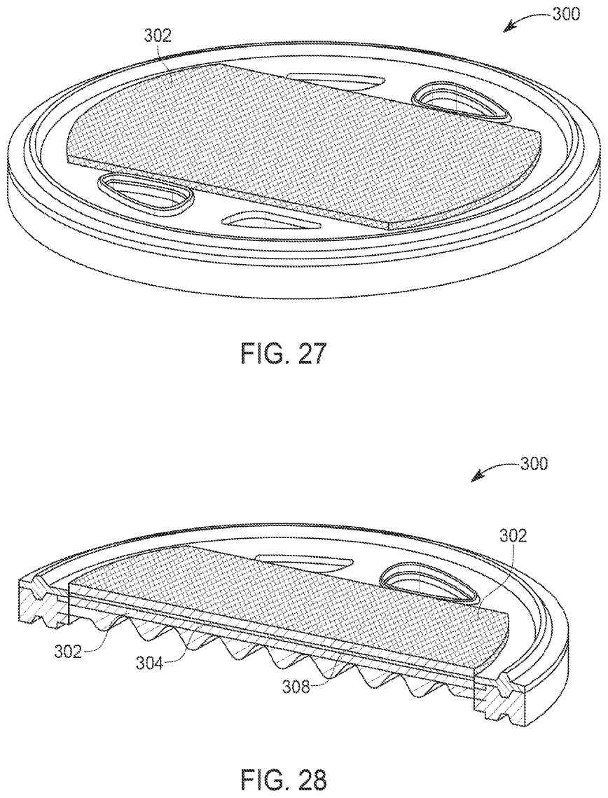

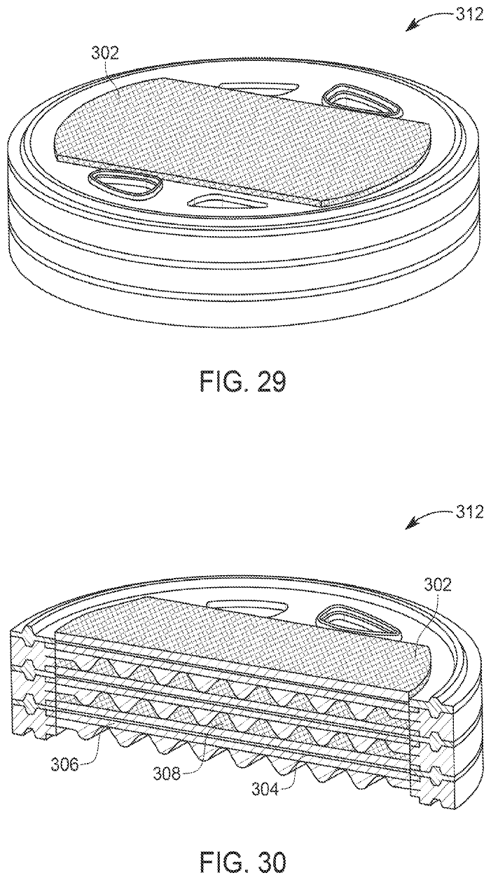

An alternative cell configuration is shown in FIGS. 27-30. A cell (300) includes an external membrane (302) that switches positions with a bipolar plate (304). Whereas the cells previously describe have the membrane (302) constrained between an anode electrode (306) and a cathode electrode (308) with the bipolar plate external to that sandwich, in the cell (300), the bipolar plate (304) is instead constrained between anode electrode (306) and cathode electrode (308). The cell (300) may form part of a stack (312) of a plurality of such cells (300).

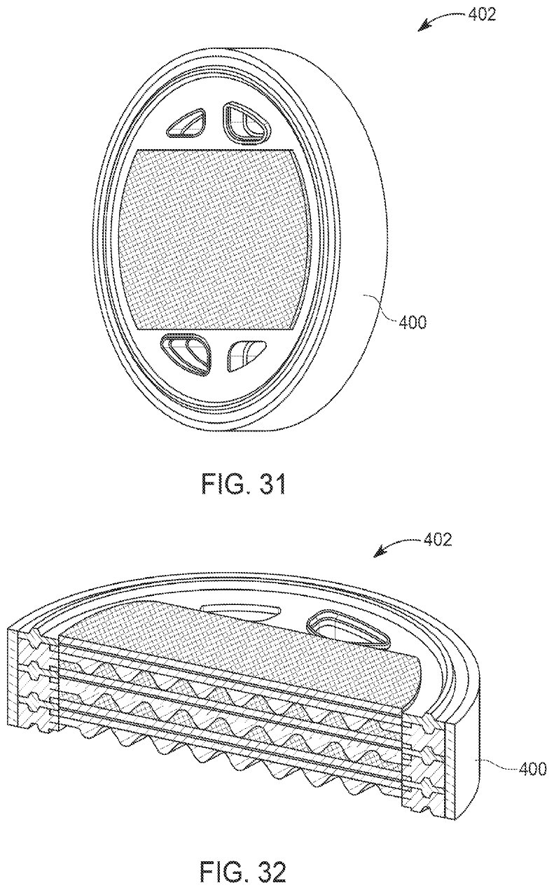

Optionally, a stack of cells may be constrained about the perimeter thereof, in addition to constraint established by end plates as described herein. Specifically, as shown in FIGS. 31 and 32, a shell (400) may be established about stack (402). The shell (400) can be added around the stack (402) to increase the pressure rating of the stack (402). The shell (400) may effectively be a metal pipe sized so the electrolyzer cells fit just inside the inner diameter of that pipe. The shell (400) can serve as a reinforcement to allow the stack (402) to go to higher pressure in operation.

The invention has been described with respect to specific examples. It is not intended to be limited by those examples. Instead, the scope of the invention is determined by the claims and all reasonable equivalents.

What is claimed is:

1. An apparatus for splitting a water feed into hydrogen and oxygen, the apparatus comprising:
a separator arranged to enable ionic exchange between an anode stream and a cathode stream of the water feed, wherein the separator is a diaphragm or a membrane;
an anode electrode attached, or in proximity, to a first side of the separator;
a cathode electrode attached, or in proximity, to a second side of the separator;
a cell frame including one or more cell inlets and one or more cell outlets together arranged to direct the anode stream to the first side of the separator and the cathode stream to the second side of the separator, wherein the cell frame is formed of a nonmetallic material insert molded over the separator to constrain the separator therein; and
a bi-polar plate made of electrically conducting material spaced from the separator and arranged to separate the anode and cathode streams passing over the anode electrode and the cathode electrode.

2. The apparatus of claim 1 wherein the apparatus is a first apparatus, wherein the first apparatus is joined to a second apparatus having the same construction as that of the first apparatus, wherein the bi-polar plate is further configured of appropriate size and shape to separate the anode and cathode streams passing over the anode and cathode electrodes of the first apparatus and the second apparatus, and further comprising an interconnector for interconnecting together the electrode of the first apparatus with the complementary electrode of the second apparatus where complementary refers to an anode-cathode pair.

3. The apparatus of claim 2 further comprising a gasket for joining together the first apparatus and the second apparatus, wherein the gasket is formed of a nonmetallic material insert molded over the bi-polar plate such that the bi-polar plate can be joined with the cell frame without inhibiting flow of the anode and cathode streams in and out of the first apparatus and the second apparatus.

4. The apparatus of claim 3 wherein the cell frame further includes an anode inlet manifold, a cathode inlet manifold, an anode outlet manifold, and a cathode outlet manifold, wherein the cell frame and the gasket are configured in such a way that when the first apparatus is joined together with the second apparatus, the cell inlets for the anode streams of the first apparatus and the second apparatus are merged into the anode inlet manifold, the cell outlets for the anode streams of the first apparatus and the second apparatus are merged into the outlet manifold, the cell inlets for the cathode streams of the first apparatus and the second apparatus are merged into the cathode inlet manifold, and the cell outlets for the cathode streams of the first apparatus and the second apparatus are merged into the cathode outlet manifold.

5. The apparatus of claim 3 wherein the cell frame and the gasket are configured in such a way that the anode and cathode streams pass on either side of the

6. (canceled)

7. The apparatus of claim 3 wherein the first apparatus combined with the second apparatus forms an electrolyzer stack, the electrolyzer stack further comprising end plates to compress the first apparatus, the second apparatus, and the gasket together to form a gas-tight seal for the stack.

8. The apparatus of claim 7 further comprising insulators arranged to isolate the end plates from electrical potential of the stack and the anode and cathode streams.

9. The apparatus of claim 8 wherein the insulators are made of an electrically insulative material by injection molding or machining.

10. (canceled)

11. (canceled)

12. (canceled)

13. (canceled)

14. An apparatus for generating electricity and water from hydrogen and oxygen of a fluid feed, the apparatus comprising:
a separator arranged in the fluid feed to enable ionic exchange between an anode stream and a cathode stream of the fluid feed, wherein the separator is a membrane;
an anode electrode attached, or in proximity, to a first side of the separator;
a cathode electrode attached, or in proximity, to a second side of the separator;
a cell frame including one or more cell inlets and one or more cell outlets together arranged to direct the anode stream to the first side of the separator and the cathode stream to the second side of the separator, wherein the cell frame is formed of a nonmetallic material insert molded over the separator to constrain the separator therein;
a bi-polar plate made of electrically conducting material spaced from the separator and arranged to separate the anode and cathode streams passing over the anode electrode and the cathode electrode; and
a first Gas Diffusion Layer (GDL) joined to the anode electrode and a second GDL joined to the cathode electrode.

15. The apparatus of claim 14 wherein the apparatus is a first apparatus, wherein the first apparatus is joined to a second apparatus having the same construction as that of the first apparatus, wherein the bi-polar plate is further configured of appropriate size and shape to separate the anode and cathode streams passing over the anode and cathode electrodes of the first apparatus and the second apparatus, and further comprising an interconnector for interconnecting together the separators of the first apparatus and the second apparatus via their respective opposing anode electrodes and cathode electrodes.

16. The apparatus of claim 15 further comprising a gasket for joining together the first apparatus and the second apparatus, wherein the gasket is formed of a nonmetallic material insert molded over the bi-polar plate such that the bi-polar plate can be joined with the cell frame without inhibiting flow of the anode and cathode streams in and out of the first apparatus and the second apparatus.

17. The apparatus of claim 16 wherein the first apparatus combined with the second apparatus forms a fuel cell stack, the fuel cell stack further comprising end plates to compress the first apparatus, the second apparatus, and the gasket together to form a gas-tight seal for the stack.

18. The apparatus of claim 17 further comprising insulators arranged to isolate the end plates from electrical potential of the stack and the anode and cathode streams.

19. (canceled)

20. A method for making an electrochemical cell, the method comprising the steps of:
securing a separator in a first mold, wherein the separator is a diaphragm or a membrane;
molding by insert molding in the first mold a cell frame over the separator to provide structural support to the separator, wherein the cell frame is formed of a nonmetallic material that is molten when inserted into the first mold and solidifies while in the first mold;
securing a bipolar plate in a second mold;
molding by insert molding in the second mold a gasket over the bipolar plate with a shape that fits the cell frame;
providing an anode electrode near a first side of the separator;
providing a cathode electrode near a second side of the separator; and
joining the bi-polar plate with the anode electrode and the cathode electrode so that the cell frame comes in contact with the gasket.

21. (canceled)

22. The method of claim 20 wherein the first mold includes a heated mold portion and a cold plate portion, wherein the heated portion is heated to enable flow of the nonmetallic material into the mold to encase a portion of the separator, and wherein the cold plate portion secures the separator in the mold and is cooled to keep a substantial portion of the separator cool while the nonmetallic material is flowing into the first mold.

23. (canceled)

24. The method of claim 23 wherein the stack is formed by tactile interlocking of corresponding portions of adjacent ones of the electrochemical cells in the stack.

25. The method of claim 23 wherein the cell frame is formed having a symmetrical design to facilitate assembly of individual electrochemical cells of the stack, wherein the symmetrical design reduces sensitivity to orientation of adjacent cell frames and gaskets.

26. (canceled)

27. (canceled)

28. (canceled)

29. The method of claim 23 further including the step of joining together a first electrochemical cell with a second electrochemical cell to establish in the stack a common anode inlet manifold into the joined cells and a common anode outlet manifold from the joined cells and likewise provides for a common cathode inlet manifold and a common cathode outlet manifold for the joined cells, in forming the stack.

30. (canceled)

31. (canceled)

32. (canceled)
